(19) United States
(12) Patent Application Publication
(10) Pub. No.: US 2026/0089765 A1
(43) Pub. Date: Mar. 26, 2026

(54) RANDOM ACCESS AND UPLINK SHARED CHANNEL OCCASION MAPPING PATTERNS FOR RANDOM ACCESS PROCEDURES

(71) Applicant: QUALCOMM Incorporated, San Diego, CA (US)

(72) Inventors: Qiaoyu LI, Beijing (CN); Junyi LI, Greentown, PA (US); Mahmoud TAHERZADEH BOROUJENI, San Diego, CA (US); Tao LUO, San Diego, CA (US); Peter GAAL, San Diego, CA (US)

(21) Appl. No.: 19/111,092

(22) PCT Filed: Oct. 14, 2022
(86) PCT No.: PCT/CN2022/125250

§ 371 Date: Mar. 12, 2025

(51) Int. Cl. H04W 74/0833; H04W 72/0446

(52) U.S. Cl. CPC H04W 74/0833; H04W 72/0446

(57) ABSTRACT

Methods, systems, and devices for wireless communication are described. A user equipment (UE) may receive control signaling indicating a time-domain mapping pattern between one or more random access occasions and one or more physical uplink shared channel (PUSCH) occasions. The UE may transmit one or more preambles of a random access message of a random access procedure in the one or more random access occasions in accordance with the time-domain mapping pattern. Additionally, the UE may transmit one or more PUSCHs (e.g., uplink payload transmissions) of the random access message in the one or more PUSCH occasions in accordance with the time-domain mapping pattern. In some examples, the UE may receive a random access response message based on a timing of the preamble and PUSCH transmissions.

### CROSS REFERENCE

The present application is a 371 national phase filing of International PCT Application No. PCT/CN2022/125250 by L I et al., entitled “RANDOM ACCESS AND UPLINK SHARED CHANNEL OCCASION MAPPING PATTERNS FOR RANDOM ACCESS PROCEDURES,” filed Oct. 14, 2022, which is assigned to the assignee hereof, and which is expressly incorporated by reference in its entirety herein.

### FIELD OF TECHNOLOGY

The following relates to wireless communication, including random access and uplink shared channel occasion mapping patterns for random access procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a user equipment (UE) may transmit a random access message as part of a random access procedure. In some cases, the UE may transmit preambles and uplink payload in the random access message during respective resources. In some cases, however, different time-domain behaviors may be considered for such transmissions.

### SUMMARY

The described techniques relate to improved methods, systems, devices, and apparatuses that support random access and uplink shared channel occasion mapping patterns for random access procedures. For example, the described techniques provide for mapping patterns for random access (RACH) occasions and uplink shared channel occasions for two-step RACH procedures. In some examples, a user equipment (UE) may receive control signaling from a network entity indicating a time-domain mapping pattern between one or more RACH occasions and one or more uplink shared channel occasions. The UE may transmit one or more preambles of a RACH message in the one or more RACH occasions in accordance with the indicated time-domain mapping pattern. In addition, the UE may transmit one or more uplink payload transmissions of the RACH message in the one or more uplink shared channel occasions in accordance with the indicated time-domain mapping pattern. In some examples, different RACH and uplink shared channel occasion mapping patterns may be associated with one or more repetition levels or synchronization signal blocks (SSBs).

A method for wireless communication at a UE is described. The method may include receiving control signaling indicating a time-domain mapping pattern between one or more random access occasions and one or more uplink shared channel occasions for transmission of a random access message of a random access procedure, transmitting, in the one or more random access occasions in accordance with the time-domain mapping pattern, one or more preambles of the random access message of the random access procedure, and transmitting, in the one or more uplink shared channel occasions in accordance with the time-domain mapping pattern, one or more uplink payload transmissions of the random access message of the random access procedure.

An apparatus for wireless communication at a UE is described. The apparatus may include a processor, memory coupled with the processor, and instructions stored in the memory. The instructions may be executable by the processor to cause the apparatus to receive control signaling indicating a time-domain mapping pattern between one or more random access occasions and one or more uplink shared channel occasions for transmission of a random access message of a random access procedure, transmit, in the one or more random access occasions in accordance with the time-domain mapping pattern, one or more preambles of the random access message of the random access procedure, and transmit, in the one or more uplink shared channel occasions in accordance with the time-domain mapping pattern, one or more uplink payload transmissions of the random access message of the random access procedure.

Another apparatus for wireless communication at a UE is described. The apparatus may include means for receiving control signaling indicating a time-domain mapping pattern between one or more random access occasions and one or more uplink shared channel occasions for transmission of a random access message of a random access procedure, means for transmitting, in the one or more random access occasions in accordance with the time-domain mapping pattern, one or more preambles of the random access message of the random access procedure, and means for transmitting, in the one or more uplink shared channel occasions in accordance with the time-domain mapping pattern, one or more uplink payload transmissions of the random access message of the random access procedure.

A non-transitory computer-readable medium storing code for wireless communication at a UE is described. The code may include instructions executable by a processor to receive control signaling indicating a time-domain mapping pattern between one or more random access occasions and one or more uplink shared channel occasions for transmission of a random access message of a random access procedure, transmit, in the one or more random access occasions in accordance with the time-domain mapping pattern, one or more preambles of the random access message of the random access procedure, and transmit, in the one or more uplink shared channel occasions in accordance with the time-domain mapping pattern, one or more uplink payload transmissions of the random access message of the random access procedure.

Some examples of the method, apparatuses, and non-transitory computer-readable medium described herein may further include operations, features, means, or instructions for transmitting, in accordance with the time-domain mapping pattern, the one or more preambles in one or more consecutive random access occasions and the one or more uplink payload transmissions in one or more consecutive uplink shared channel occasions, where the one or more consecutive uplink shared channel occasions may be subsequent to the one or more consecutive random access occasions.

Some examples of the method, apparatuses, and non-transitory computer-readable medium described herein may further include operations, features, means, or instructions for receiving the control signaling indicating the time-domain mapping pattern, where the time-domain mapping pattern indicates that the one or more random access occasions and the one or more uplink shared channel occasions may be interleaved in a time domain and transmitting the one or more preambles and the one or more uplink payload transmissions, where the one or more preambles and the one or more uplink payload transmissions may be interleaved based on the time-domain mapping pattern.

In some examples of the method, apparatuses, and non-transitory computer-readable medium described herein, transmitting the one or more preambles may include operations, features, means, or instructions for transmitting, in accordance with the time-domain mapping pattern, the one or more preambles in one or more consecutive random access occasions that may be time division multiplexed (TDMed) within one or more random access slots.

In some examples of the method, apparatuses, and non-transitory computer-readable medium described herein, transmitting the one or more uplink payload transmissions may include operations, features, means, or instructions for transmitting, in accordance with the time-domain mapping pattern, the one or more uplink payload transmissions in one or more consecutive uplink shared channel occasions that may be TDMed, where the one or more uplink payload transmissions may be associated with a subset of the one or more preambles.

Some examples of the method, apparatuses, and non-transitory computer-readable medium described herein may further include operations, features, means, or instructions for transmitting, in accordance with the time-domain mapping pattern, the one or more preambles in the one or more random access occasions and a first uplink payload transmission of the one or more uplink payload transmissions in a first uplink shared channel occasion of the one or more uplink shared channel occasions.

Some examples of the method, apparatuses, and non-transitory computer-readable medium described herein may further include operations, features, means, or instructions for transmitting, in accordance with the time-domain mapping pattern, a first preamble of the one or more preambles in a first random access occasion of the one or more random access occasions and the one or more uplink payload transmissions in the one or more uplink shared channel occasions.

Some examples of the method, apparatuses, and non-transitory computer-readable medium described herein may further include operations, features, means, or instructions for receiving the control signaling indicating the time-domain mapping pattern between the one or more random access occasions and the one or more uplink shared channel occasions, the time-domain mapping pattern based on a set of joint preamble and uplink payload transmission repetitions associated with one or more repetition levels, where the set of joint preamble and uplink payload transmission repetitions may be TDMed, frequency division multiplexed (FDMed), or code division multiplexed (CDMed).

In some examples of the method, apparatuses, and non-transitory computer-readable medium described herein, for the set of joint preamble and uplink payload transmission repetitions that may be CDMed, a first joint payload and uplink payload transmission repetition may be associated with one or more repetition levels.

Some examples of the method, apparatuses, and non-transitory computer-readable medium described herein may further include operations, features, means, or instructions for receiving a random access response (RAR) message in an RAR window, where a beginning of the RAR window may be based on a last symbol of a last preamble of the one or more preambles or a last uplink payload transmission of the one or more uplink payload transmissions associated with a first repetition level.

Some examples of the method, apparatuses, and non-transitory computer-readable medium described herein may further include operations, features, means, or instructions for transmitting a set of joint preamble and uplink payload transmission repetitions, where the set of joint preamble and uplink payload transmission repetitions may be associated with one or more SSBs for a given repetition level.

Some examples of the method, apparatuses, and non-transitory computer-readable medium described herein may further include operations, features, means, or instructions for selecting a first joint preamble and uplink payload transmission repetition of the set of joint preamble and uplink payload transmission repetitions based on an SSB associated with the first joint preamble and uplink payload transmission repetition corresponding to a highest identified reference signal received power (RSRP).

In some examples of the method, apparatuses, and non-transitory computer-readable medium described herein, a quantity of SSBs associated with a highest identified RSRP may be associated with a repetition level.

A method for wireless communication at a network entity is described. The method may include transmitting control signaling indicating a time-domain mapping pattern between one or more random access occasions and one or more uplink shared channel occasions for transmission of a random access message of a random access procedure, receiving, in the one or more random access occasions in accordance with the time-domain mapping pattern, one or more preambles of the random access message of the random access procedure, and receiving, in the one or more uplink shared channel occasions in accordance with the time-domain mapping pattern, one or more uplink payload transmissions of the random access message of the random access procedure.

An apparatus for wireless communication at a network entity is described. The apparatus may include a processor, memory coupled with the processor, and instructions stored in the memory. The instructions may be executable by the processor to cause the apparatus to transmit control signaling indicating a time-domain mapping pattern between one or more random access occasions and one or more uplink shared channel occasions for transmission of a random access message of a random access procedure, receive, in the one or more random access occasions in accordance with the time-domain mapping pattern, one or more preambles of the random access message of the random access procedure, and receive, in the one or more uplink shared channel occasions in accordance with the time-domain mapping pattern, one or more uplink payload transmissions of the random access message of the random access procedure.

Another apparatus for wireless communication at a network entity is described. The apparatus may include means for transmitting control signaling indicating a time-domain mapping pattern between one or more random access occasions and one or more uplink shared channel occasions for transmission of a random access message of a random access procedure, means for receiving, in the one or more random access occasions in accordance with the time-domain mapping pattern, one or more preambles of the random access message of the random access procedure, and means for receiving, in the one or more uplink shared channel occasions in accordance with the time-domain mapping pattern, one or more uplink payload transmissions of the random access message of the random access procedure.

A non-transitory computer-readable medium storing code for wireless communication at a network entity is described. The code may include instructions executable by a processor to transmit control signaling indicating a time-domain mapping pattern between one or more random access occasions and one or more uplink shared channel occasions for transmission of a random access message of a random access procedure, receive, in the one or more random access occasions in accordance with the time-domain mapping pattern, one or more preambles of the random access message of the random access procedure, and receive, in the one or more uplink shared channel occasions in accordance with the time-domain mapping pattern, one or more uplink payload transmissions of the random access message of the random access procedure.

Some examples of the method, apparatuses, and non-transitory computer-readable medium described herein may further include operations, features, means, or instructions for receiving, in accordance with the time-domain mapping pattern, the one or more preambles in one or more consecutive random access occasions and the one or more uplink payload transmissions in one or more consecutive uplink shared channel occasions, where the one or more consecutive uplink shared channel occasions may be subsequent to the one or more consecutive random access occasions.

Some examples of the method, apparatuses, and non-transitory computer-readable medium described herein may further include operations, features, means, or instructions for transmitting the control signaling indicating the time-domain mapping pattern, where the time-domain mapping pattern indicates that the one or more random access occasions and the one or more uplink shared channel occasions may be interleaved in a time domain and receiving the one or more preambles and the one or more uplink payload transmissions, where the one or more preambles and the one or more uplink payload transmissions may be interleaved based on the time-domain mapping pattern.

In some examples of the method, apparatuses, and non-transitory computer-readable medium described herein, receiving the one or more preambles may include operations, features, means, or instructions for receiving, in accordance with the time-domain mapping pattern, the one or more preambles in one or more consecutive random access occasions that may be TDMed within one or more random access slots.

In some examples of the method, apparatuses, and non-transitory computer-readable medium described herein, receiving the one or more uplink payload transmissions may include operations, features, means, or instructions for receiving, in accordance with the time-domain mapping pattern, the one or more uplink payload transmissions in one or more consecutive uplink shared channel occasions that may be TDMed, where the one or more uplink payload transmissions may be associated with a subset of the one or more preambles.

Some examples of the method, apparatuses, and non-transitory computer-readable medium described herein may further include operations, features, means, or instructions for receiving, in accordance with the time-domain mapping pattern, the one or more preambles in the one or more random access occasions and a first uplink payload transmission of the one or more uplink payload transmissions in a first uplink shared channel occasion of the one or more uplink shared channel occasions.

Some examples of the method, apparatuses, and non-transitory computer-readable medium described herein may further include operations, features, means, or instructions for receiving, in accordance with the time-domain mapping pattern, a first preamble of the one or more preambles in a first random access occasion of the one or more random access occasions and the one or more uplink payload transmissions in the one or more uplink shared channel occasions.

Some examples of the method, apparatuses, and non-transitory computer-readable medium described herein may further include operations, features, means, or instructions for transmitting the control signaling indicating the time-domain mapping pattern between the one or more random access occasions and the one or more uplink shared channel occasions, the time-domain mapping pattern based on a set of joint preamble and uplink payload transmission repetitions associated with one or more repetition levels, where the set of joint preamble and uplink payload transmission repetitions may be TDMed, FDMed, or CDMed.

In some examples of the method, apparatuses, and non-transitory computer-readable medium described herein, for the set of joint preamble and uplink payload transmission repetitions that may be CDMed, a first joint payload and uplink payload transmission repetition may be associated with one or more repetition levels.

Some examples of the method, apparatuses, and non-transitory computer-readable medium described herein may further include operations, features, means, or instructions for transmitting an RAR message in an RAR window, where a beginning of the RAR window may be based on a last symbol of a last preamble of the one or more preambles or a last uplink payload transmission of the one or more uplink payload transmissions associated with a first repetition level.

Some examples of the method, apparatuses, and non-transitory computer-readable medium described herein may further include operations, features, means, or instructions for receiving a set of joint preamble and uplink payload transmission repetitions, where the set of joint preamble and uplink payload transmission repetitions may be associated with one or more SSBs for a given repetition level.

In some examples of the method, apparatuses, and non-transitory computer-readable medium described herein, a quantity of SSBs associated with a highest identified RSRP may be associated with a repetition level.

### BRIEF DESCRIPTION OF THE DRAWINGS

FIG. 1 illustrates an example of a wireless communications system that supports random access and uplink shared channel occasion mapping patterns for random access procedures in accordance with one or more aspects of the present disclosure.

FIG. 2 illustrates an example of a wireless communications system that supports random access and uplink shared channel occasion mapping patterns for random access procedures in accordance with one or more aspects of the present disclosure.

FIG. 3 through 9 illustrate examples of time-domain mapping patterns that support random access and uplink shared channel occasion mapping patterns for random access procedures in accordance with one or more aspects of the present disclosure.

FIG. 10 illustrates an example of a process flow that supports random access and uplink shared channel occasion mapping patterns for random access procedures in accordance with one or more aspects of the present disclosure.

FIGS. 11 and 12 show block diagrams of devices that support random access and uplink shared channel occasion mapping patterns for random access procedures in accordance with one or more aspects of the present disclosure.

FIG. 13 shows a block diagram of a communications manager that supports random access and uplink shared channel occasion mapping patterns for random access procedures in accordance with one or more aspects of the present disclosure.

FIG. 14 shows a diagram of a system including a device that supports random access and uplink shared channel occasion mapping patterns for random access procedures in accordance with one or more aspects of the present disclosure.

FIGS. 15 and 16 show block diagrams of devices that support random access and uplink shared channel occasion mapping patterns for random access procedures in accordance with one or more aspects of the present disclosure.

FIG. 17 shows a block diagram of a communications manager that supports random access and uplink shared channel occasion mapping patterns for random access procedures in accordance with one or more aspects of the present disclosure.

FIG. 18 shows a diagram of a system including a device that supports random access and uplink shared channel occasion mapping patterns for random access procedures in accordance with one or more aspects of the present disclosure.

FIGS. 19 through 24 show flowcharts illustrating methods that support random access and uplink shared channel occasion mapping patterns for random access procedures in accordance with one or more aspects of the present disclosure.

### DETAILED DESCRIPTION

A user equipment (UE) may perform a two-step random access procedure (also referred to herein as a RACH procedure). The two-step random access procedure may include transmission of a first message (e.g., MsgA) and a second message (e.g., MsgB), where the first message may include a RACH preamble transmission and an uplink payload transmission. In some cases, because of a minimum transmission gap between the preamble and uplink payload, the UE may use a particular mapping pattern to map RACH occasions to physical uplink shared channel (PUSCH) occasions for transmission of the first message. For example, the UE may map each consecutive quantity of preamble indexes from valid RACH occasions in a given slot to a valid PUSCH occasion in an associated demodulation reference signal (DMRS) resource. However, specifying details of the RACH occasion-PUSCH occasion mapping patterns when considering joint transmissions of preamble and uplink payload repetitions may reduce latency of RACH procedures without limiting coverage of the UE. For example, the UE may consider some different time domain behaviors for particular joint RACH occasion and PUSCH occasion repetitions, repetition levels, and synchronization signal blocks (SSBs), which may impact mapping patterns.

The described techniques support mapping patterns for RACH occasions and uplink shared channel (e.g., PUSCH) occasions for two-step RACH procedures. In some examples, a UE may receive control signaling from a network entity indicating a time-domain mapping pattern between one or more RACH occasions and one or more uplink shared channel occasions. The UE may transmit one or more preambles of a RACH message in the one or more RACH occasions in accordance with the indicated time-domain mapping pattern. In addition, the UE may transmit one or more uplink payload transmissions of the RACH message in the one or more uplink shared channel occasions in accordance with the indicated time-domain mapping pattern. In some examples, different RACH and uplink shared channel occasion mapping patterns may be associated with one or more repetition levels or SSBs, and the UE may select a particular mapping pattern for the RACH procedure.

Aspects of the disclosure are initially described in the context of wireless communications systems. Aspects of the disclosure are then described in the context of time-domain mapping patterns and process flows. Aspects of the disclosure are further illustrated by and described with reference to apparatus diagrams, system diagrams, and flowcharts that relate to random access and uplink shared channel occasion mapping patterns for random access procedures.

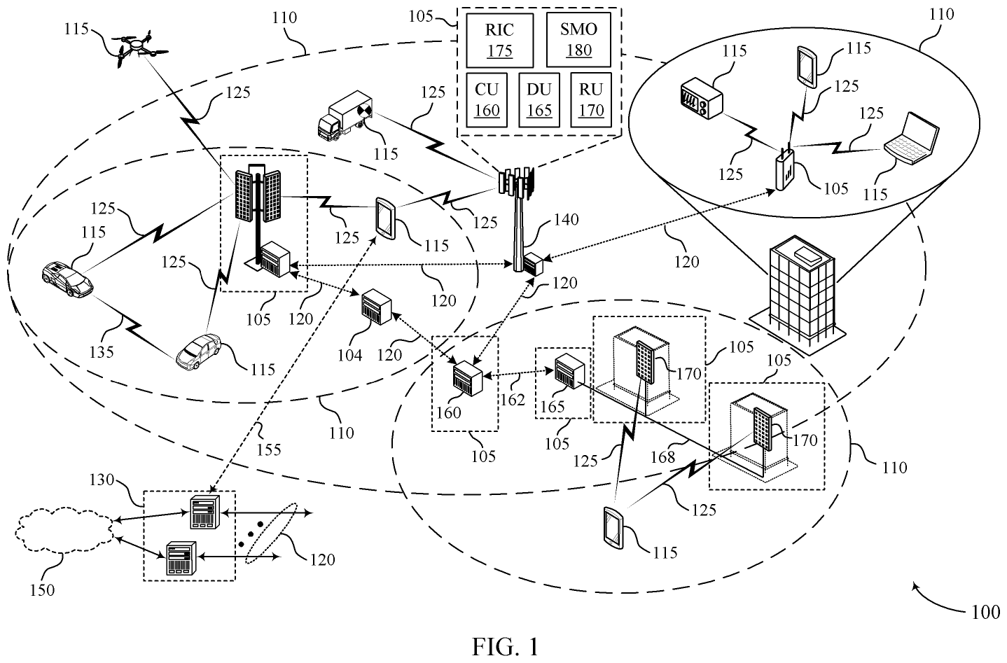

FIG. 1 illustrates an example of a wireless communications system 100 that supports random access and uplink shared channel occasion mapping patterns for random access procedures in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support random access and uplink shared channel occasion mapping patterns for random access procedures as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

A UE 115 in the wireless communications system 100 may perform a random access procedure (also referred to as a RACH procedure). In some examples, a first transmission of the RACH procedure may be referred to as a Msg1 preamble (e.g., physical random access channel (PRACH)) for a 4-step RACH procedure or a Message A (MsgA) preamble or PUSCH for a 2-step RACH procedure. A second transmission of the RACH procedure may be referred to as a Message 2 preamble (e.g., a random access response (RAR) message) for the 4-step RACH procedure and a Message B (MsgB) message for the 2-step RACH procedure. The 4-step RACH procedure may additionally include a third transmission referred to as a Msg3 scheduled transmission (e.g., PUSCH repetition), and a fourth transmission referred to as a Msg4 contention resolution message.

In some examples, the UE 115 may request a Msg3 PUSCH repetition via one or more PRACH resources, where criteria for the Msg3 repetition request may be based on a synchronization signal reference signal received power (SS-RSRP). In some cases, a UE 115 may use PRACH repetition for 4-step RACH and preamble repetition for 4-step RACH.

Some UEs 115 may use RACH occasion-PUSCH occasion mapping patterns to perform a two-step RACH procedure. In some examples, a minimum transmission gap (e.g., T_{gap}) between the MsgA preamble and the MsgA payload (e.g., PUSCH transmission) may be 2 symbols (e.g., μ=0 or 1) or 4 symbols (e.g., μ=2 or 3). Additionally, the RACH occasions and associated PUSCH occasions may be located in different slots. In such a RACH occasion-PUSCH occasion mapping pattern, each consecutive quantity of N_{preamble} preamble indices from valid RACH occasions in a RACH slot (also referred to as PRACH occasions in a PRACH slot) may be mapped to a valid PUSCH occasion and an associated DMRS resource. That is, there may be one or more RACH occasions associated with a preamble mapped to a single PUSCH occasion, where the PUSCH occasions may be intra-slot or inter-slot.

In some examples, the network entity 105 may map RACH occasions in increasing order of preamble indices within a single RACH occasion, in increasing order of frequency resource indices for frequency-multiplexed RACH occasions, or in increasing order of time resource indices for time-multiplexed RACH occasions within a RACH slot. Accordingly, the RACH occasions may be mapped to PUSCH occasions in increasing order of frequency resource indices f_{id} for frequency-multiplexed PUSCH occasions, in increasing order of DMRS resource indices within a PUSCH occasion, where a DMRS resource index DMRS_{id} is determined first in an ascending order of a DMRS port index and second in an ascending order of a DMRS resource index, in increasing order of time resource indices t_{id} for time-multiplexed PUSCH occasions within a PUSCH slot, or in increasing order of indices for Nₛ PUSCH slots. In such cases,

$${N}_{preamble} = ceil ( \frac{{T}_{preamble}}{{T}_{PUSCH}} ) ,$$

where T_{preamble} may represent a total quantity of value RACH occasions per association pattern period multiplied by a quantity of preambles per value RACH occasion provided by rach-ConfigCommonTwoStepRA, and T_{PUSCH} may represent a total quantity of PUSCH occasions per PUSCH configuration per association pattern period multiplied by a quantity of DMRS resource indices per valid PUSCH occasion provided by msgA-DMRS-Config.

In some cases, details of RACH occasion-PUSCH occasion mapping patterns may be lacking when considering joint MsgA preamble and MsgA payload (e.g., PUSCH) repetitions. For example, the network entity 105 may consider different time-domain behaviors of joint preamble and PUSCH repetitions. In some examples, the network entity 105 may repeat MsgA preambles first, then repeat MsgA PUSCH transmissions. Alternatively, the network entity 105 may interleave the MsgA preamble and PUSCH repetitions. When the network entity 105 uses different repetition levels, the RACH occasion-PUSCH occasion mapping patterns for different repetition levels may be time division multiplexed (TDMed), frequency division multiplexed (FDMed), or code division multiplexed (CDMed). If the network entity 105 uses different SSBs, different repetitions may be associated with a same SSB or different SSBs. Accordingly, if the network entity 105 fails to specify time-domain behaviors, repetition level usage, and SSB associations for a RACH occasion-PUSCH occasion mapping pattern, the UE 115 may experience increased latency and decreased signaling throughput.

The wireless communications system 100 supports the inclusion of additional details to a 2-step RACH procedure RACH occasion-PUSCH occasion mapping pattern, which may support joint MsgA preamble and MsgA PUSCH repetitions. Using the techniques described herein, a network entity 105 may include time-domain behaviors, repetition levels, and SSBs in a RACH occasion-PUSCH occasion mapping pattern. The UE 115 may receive control signaling indicating a time-domain mapping pattern between one or more RACH occasions and one or more PUSCH (e.g., uplink shared channel) occasions for transmission of a random access message in a RACH procedure. The UE 115 may transmit one or more preambles (e.g., MsgA preambles) of the random access message in one or more RACH occasions in accordance with the time-domain mapping pattern, and one or more uplink payload transmissions (e.g., MsgA PUSCH transmissions) in the one or more PUSCH occasions in accordance with the time-domain mapping pattern. In this way, the UE 115 may realize decreased latency and increased signaling throughput, while maintaining its coverage.

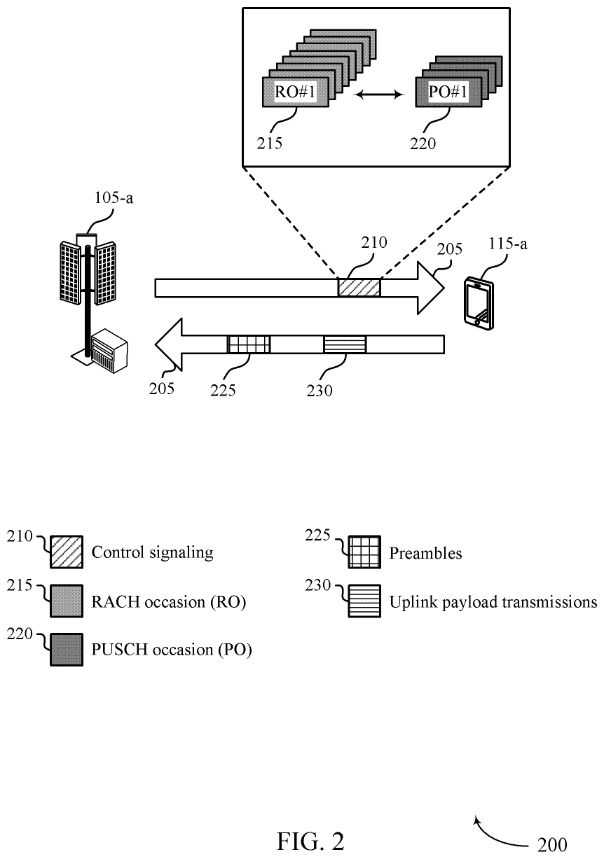

FIG. 2 illustrates an example of a wireless communications system 200 that supports random access and uplink shared channel occasion mapping patterns for random access procedures in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a and a network entity 105-a, which may be examples of corresponding devices as described herein. In some examples, the UE 115-a may perform a 2-step RACH procedure during which the UE 115-a may transmit one or more preambles and one or more uplink payload transmissions (e.g., PUSCH transmissions) of a random access message for a RACH procedures.

The wireless communications system 200 may support communications between the UE 115-a and the network entity 105-a. For example, the UE 115-a may receive downlink transmissions from the network entity 105-a and transmit uplink transmissions to the network entity 105-a via respective communication links 205, which may be examples of communication links 125 described with reference to FIG. 1. In some examples, the UE 115-a may receive control signaling 210 from the network entity 105-a. The control signaling 210 may indicate a time-domain mapping pattern between one or more RACH occasions 215 and one or more PUSCH occasions 220 (e.g., uplink shared channel occasions) for transmission of the random access message of the RACH procedure. That is, the random access message may be a MsgA transmission (e.g., a first transmission) of the RACH procedure.

In some cases, the UE 115-a may transmit one or more preambles 225 in one or more RACH occasions 215 in accordance with the time-domain mapping pattern. The preambles 225 may be part of the random access message (e.g., MsgA) of the RACH procedure. In addition, the UE 115-a may transmit one or more uplink payload transmissions 230 in one or more PUSCH occasions 220 in accordance with the time-domain mapping pattern. In some cases, the UE 115-a may transmit one or more repetitions of the preambles 225 and the uplink payload transmissions 230 based on the pattern of the RACH occasions 215 and the PUSCH occasions 220. For example, the UE 115-a may repeat the preambles 225 and then repeat the uplink payload transmissions 230 consecutively, or the UE 115-a may interleave the preambles 225 and the uplink payload transmissions 230 based on the interleaved RACH and PUSCH occasions.

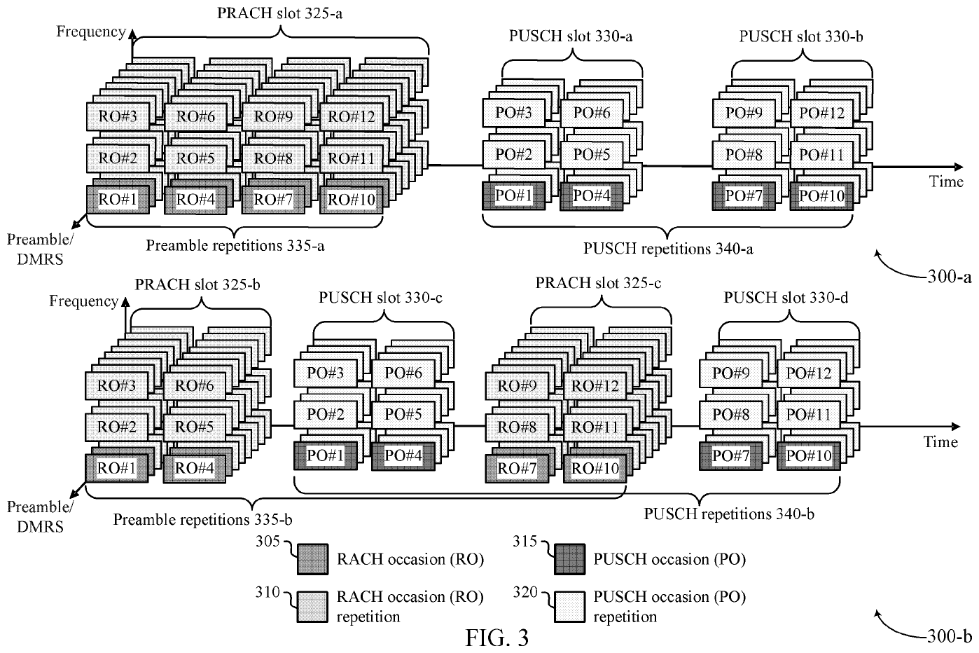

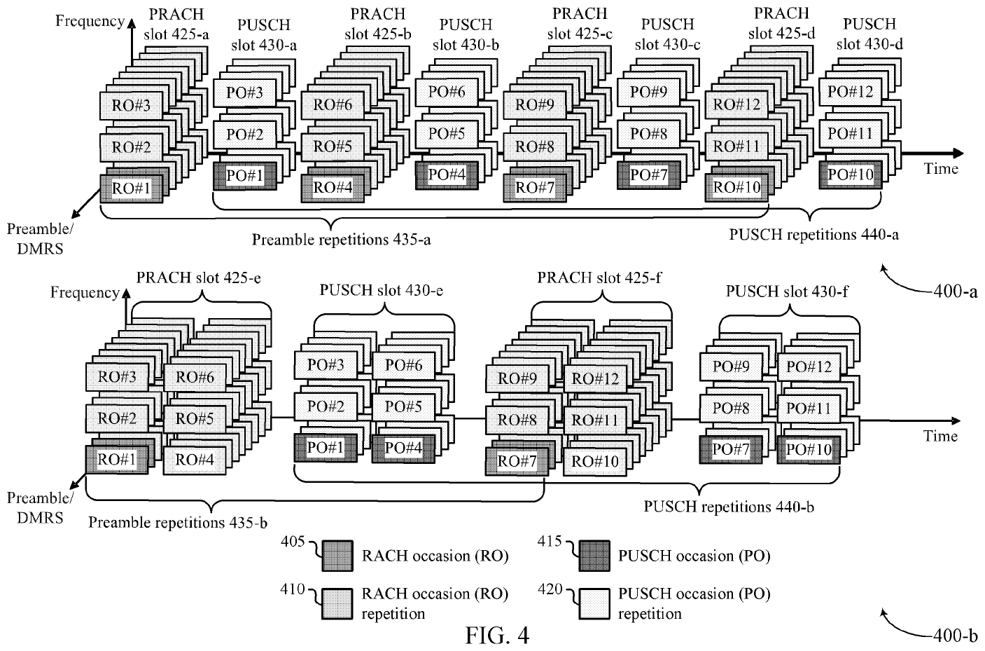

The time-domain mapping pattern may detail a mapping between the RACH occasions 215 and the PUSCH occasions 220. In some cases, the time-domain mapping pattern may specify time-domain behaviors of the RACH occasions 215 and the PUSCH occasions 220. For example, the network entity 105-a may repeat the RACH occasions 215 and then the PUSCH occasions 220 consecutively, or the network entity 105-a may interleave the PUSCH occasions 220 between the RACH occasions 215. The network entity 105-a may also map the RACH occasions 215 and the PUSCH occasions 220 to specific resources (e.g., PRACH slots and PUSCH slots, respectively). The UE 115-a may use the RACH occasions 215 and the PUSCH occasions 220 to transmit preambles and PUSCH transmissions, respectively, of the random access message. Such time-domain behaviors of the RACH occasions 215 and the PUSCH occasions 220 are described herein with reference to FIGS. 3 and 4.

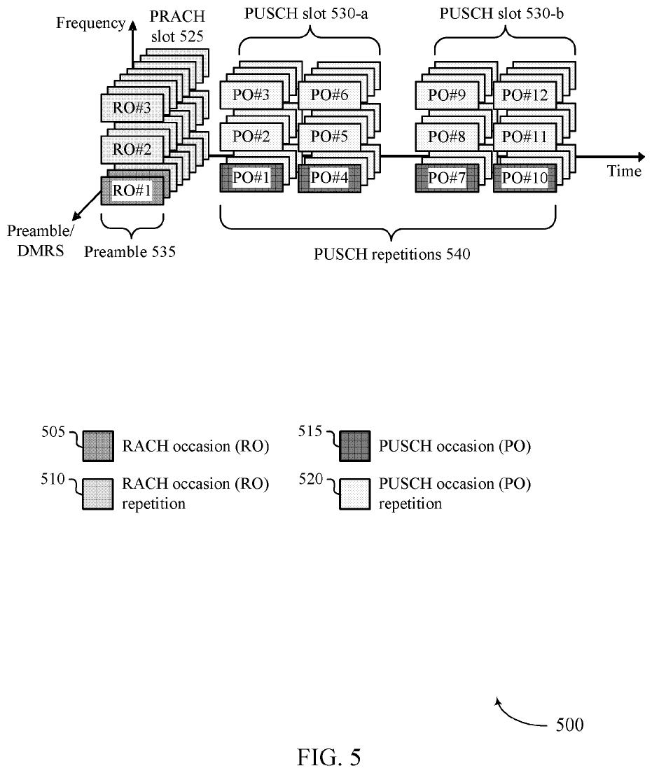

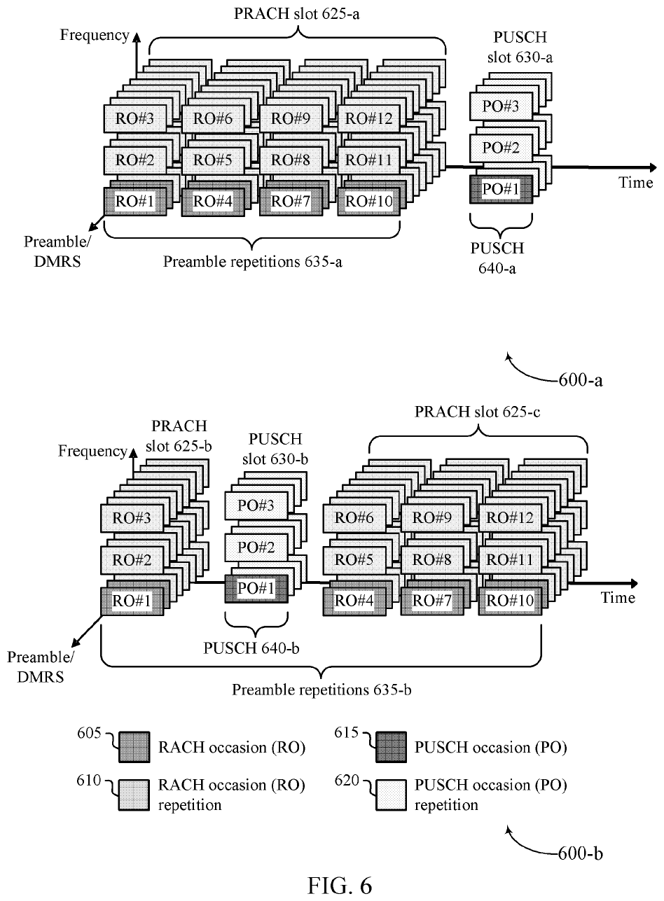

In some examples, the network entity 105-a may configure the time-domain mapping pattern such that the UE 115-a may repeat only the preambles or the PUSCH transmissions of the random access message. For example, the UE 115-a may transmit preamble repetitions in multiple RACH occasions 215 and a single PUSCH in a single PUSCH occasion 220, or the UE 115-a may transmit a single preamble in a single RACH occasion 215 and one or multiple PUSCH repetitions in one or multiple PUSCH occasions 220 in accordance with the time-domain mapping pattern. Such repetition patterns are described herein with reference to FIGS. 5 and 6.

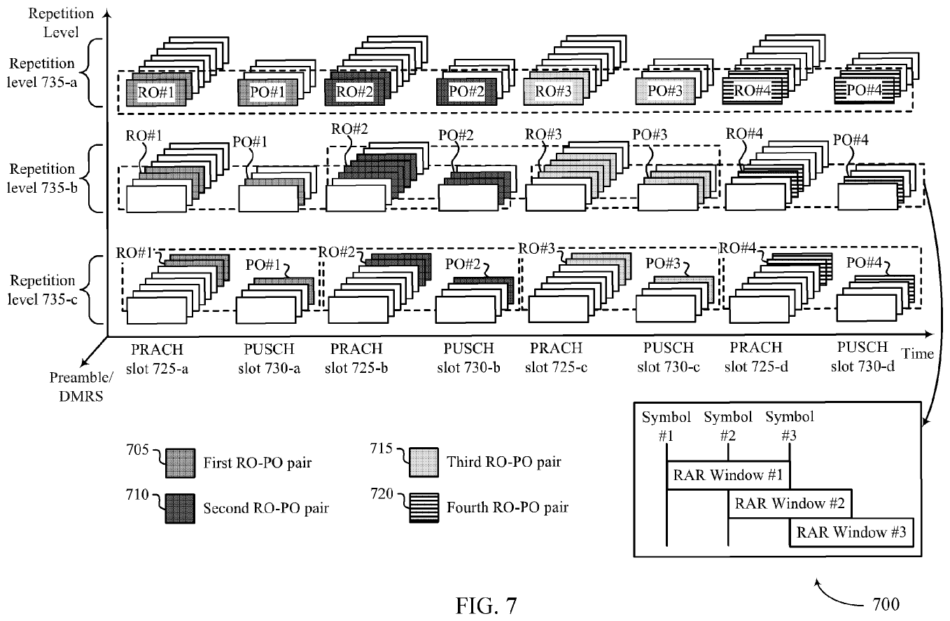

Additionally, or alternatively, the network entity 105-a may multiplex RACH occasions 215 and PUSCH occasions 220 among different repetition levels. For example, mapped RACH occasion-PUSCH occasion pairs associated with different repetition levels may be TDMed, FDMed, or CDMed. The UE 115-a may transmit different preambles and DMRS resources, as indicated by the network entity 105-a, for respective RACH occasions 215 and PUSCH occasions 220 based on corresponding repetition levels. The repetition level configurations are described herein with respect to FIG. 7.

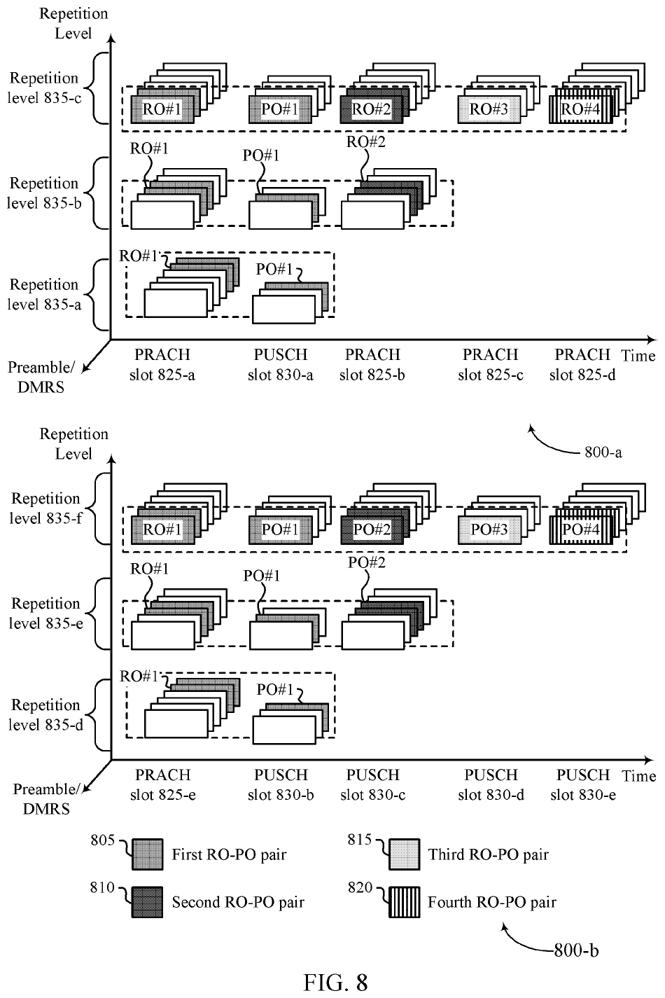

In some cases, the network entity 105-a may transmit an RAR message (e.g., a second message of the RACH procedure, MsgB) to the UE 115-a based on the time-domain mapping pattern. For example, the network entity 105-a may determine a beginning of an RAR window based on a last symbol of a last preamble or PUSCH repetition of a particular repetition level. The RAR window may be based on repeated preambles 225 and corresponding RACH occasions 215, repeated uplink payload transmissions 230 and corresponding PUSCH occasions 220, or a combination thereof. The RAR message transmission is described herein with reference to FIG. 8.

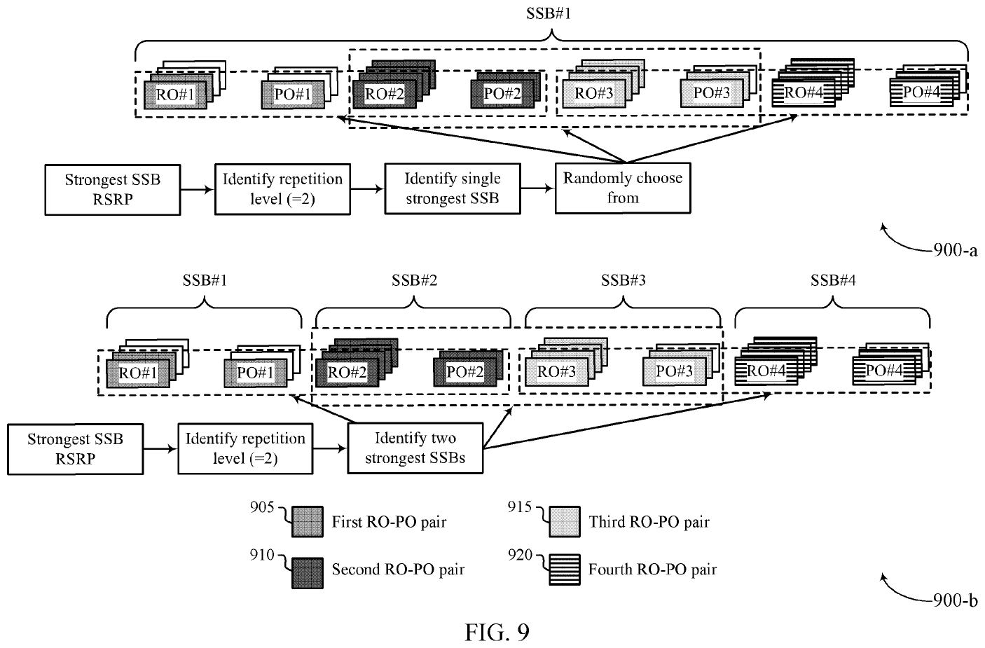

In some examples, the network entity 105-a may multiplex different RACH occasions 215 and PUSCH occasions 220 based on different SSBs. For example, different joint preamble and PUSCH repetitions may be associated with a same SSB or different SSBs, and a UE 115-a may select a particular time-domain mapping pattern based on measured RSRPs of the one or more SSBs. The time-domain mapping pattern based on one or more SSBs is described herein with referent to FIG. 9.

FIG. 3 illustrates an example of time-domain mapping patterns 300 that supports random access and uplink shared channel occasion mapping patterns for random access procedures in accordance with one or more aspects of the present disclosure. In some examples, the time-domain mapping patterns 300 may implement aspects of the wireless communications systems 100 and 200 or may be implemented by aspects of the wireless communications systems 100 and 200. For example, a network entity 105-a may configure a time-domain mapping patterns 300-a and a time-domain mapping pattern 300-b to each include one or more RACH occasions 305 and one or more PUSCH occasions 315 (e.g., uplink shared channel occasions). In some examples, the time-domain mapping pattern 300-a may include consecutive RACH occasions and PUSCH occasions, and the time-domain mapping pattern 300-b may include interleaved RACH occasions and PUSCH occasions.

The UE 115-a may identify one or more RACH occasions 305 and one or more PUSCH occasions 315 for joint MsgA preamble and MsgA PUSCH transmissions based on configurations indicated from the network entity 105-a. For example, the UE 115-a may receive control signaling indicating the time-domain mapping pattern 300-a or the time-domain mapping pattern 300-b, where a time-domain mapping pattern 300 may include one or more RACH occasions 305 and one or more PUSCH occasions 315 for transmission of a random access message of a RACH procedure. That is, the random access message (e.g., MsgA) may be a first transmission of a 2-step RACH procedure that includes preamble and PUSCH (e.g., uplink payload) transmissions. The network entity 105-a may transmit the control signaling via remaining minimum system information (RMSI) or UE-specific RRC signaling.

The time-domain mapping pattern 300-a may be based on a repetition of the RACH occasions 305 including corresponding preambles, and the PUSCH occasions 315 including corresponding uplink payload transmissions (e.g., PUSCH transmissions). For example, the network entity 105-a may configure the time-domain mapping pattern 300-a such that the UE 115-a repeats one or more MsgA preambles based on a corresponding set of RACH occasions 305, and then repeats one or more MsgA PUSCH transmissions based on a corresponding set of PUSCH occasions 315.

Regarding the time-domain mapping pattern 300-a, the network entity 105-a may configure a set of twelve RACH occasions (also referred to herein as ROs) across the time domain, a frequency domain, and a preamble-based domain in a PRACH slot 325-a. The twelve RACH occasions may include four RACH occasions 305 and eight RACH occasion repetitions 310. The RACH occasions 305 may include RACH occasions 305 RO #1 RO #4, RO #7, and RO #10 repeated in the time domain. In addition, the RO #1 may correspond to two RACH occasion repetitions 310 RO #2 and RO #3, the RO #4 may correspond to two RACH occasion repetitions 310 RO #5 and RO #6 in the frequency domain, the RO #7 may correspond to two RACH occasion repetitions 310 RO #8 and RO #9 in the frequency domain, and the RO #10 may correspond to two RACH occasion repetitions 310 RO #11 and RO #12 in the frequency domain.

Additionally, each RACH occasion 305 and each RACH occasion repetition 310 (including the RO #1 through the RO #12) may correspond to one or more preambles. For example, the RACH occasion 305 corresponding to RO #1 may correspond to two preamble repetitions (the two RACH occasions 305 RO #1 as shown). The RO #4, the RO #7, and the RO #10 may each correspond to two different preambles. In this way, the PRACH slot 325-a may include four MsgA preamble repetitions 335-a with respect to two different preambles.

In addition, the network entity 105-a may configure a set of twelve PUSCH occasions (also referred to herein as POs) across the time-domain, the frequency-domain, and a DMRS-based domain in PUSCH slots 330. The twelve PUSCH occasions may include four PUSCH occasions 315 and eight PUSCH occasion repetitions 320. A PUSCH slot 330-a may include PUSCH occasions 315 PO #1 and PO #4 repeated in the time domain. In addition, the PO #1 may correspond to two PUSCH occasion repetitions 320 PO #2 and PO #3, and the PO #4 may correspond to two PUSCH occasion repetitions 320 PO #5 and PO #6 in the frequency domain. A PUSCH slot 330-b may include PUSCH occasions 315 PO #7 and PO #10 repeated in the time domain. In addition, the PO #7 may correspond to two PUSCH occasion repetitions 320 PO #8 and PO #9, and the PO #10 may correspond to two PUSCH occasion repetitions 320 PO #11 and PO #12 in the frequency domain. As such, the network entity 105-a may repeat four PUSCH occasions 315 across the PUSCH slot 330-a and the PUSCH slot 330-b, where each PUSCH occasion 315 is associated with a DMRS resource.

In this way, the network entity 105-a may map the PRACH repetitions 340-a with respect to two different preambles to a same set of MsgA PUSCH repetitions 335-a. Additionally, in accordance with the time-domain mapping pattern 300-a, the UE 115-a may transmit the one or more preambles in one or more consecutive RACH occasions 305 and the one or more uplink payload transmissions in one or more consecutive PUSCH occasions 315, where the consecutive PUSCH occasions 315 are subsequent to the consecutive RACH occasions 305.

The time-domain mapping pattern 300-b may be based on an interleaving of the RACH occasions 305 including corresponding preambles, and the PUSCH occasions 315 including corresponding uplink payload transmissions (e.g., PUSCH transmissions). For example, the network entity 105-a may configure the time-domain mapping pattern 300-b such that the UE 115-a interleaves (e.g., alternates) the MsgA preamble repetitions and the MsgA PUSCH repetitions in the time domain based on interleaving the RACH occasions 305 and the PUSCH occasions 315 in the time domain. The UE 115-a may receive the control signaling from the network entity 105-a indicating the time-domain mapping pattern 300-b which indicates that the one or more RACH occasions 305 and the one or more PUSCH occasions 315 are interleaved in the time domain.

As described with reference to the time-domain mapping pattern 300-a, the time-domain mapping pattern 300-b may include a set of twelve RACH occasions across the time domain, a frequency domain, and a preamble-based domain in a PRACH slot 325-b and a PRACH slot 325-c. The PRACH slot 325-b may include RACH occasions 305 RO #1 and RO #4 repeated in the time domain. In addition, the RO #1 may correspond to two RACH occasion repetitions 310 RO #2 and RO #3 in the frequency domain, and the RO #4 may correspond to two RACH occasion repetitions 310 RO #5 and an RO #6 in the frequency domain. The PRACH slot 325-c may include RACH occasions 305 RO #7 and RO #10 repeated in the time domain. In addition, the RO #7 may correspond to two RACH occasion repetitions 310 RO #8 and RO #9 in the frequency domain, and the RO #10 may correspond to two RACH occasion repetitions 310 RO #11 and an RO #12 in the frequency domain. As described herein, each RACH occasion 305 may correspond to two preambles the UE 115-a may transmit. As such, there may be four RACH occasions 305 repeated across the PRACH slot 325-b and the PRACH slot 325-c.

In addition, the network entity 105-a may configure a PUSCH slot 330-c after the PRACH slot 325-b and before the PRACH slot 325-c, and a PUSCH slot 330-d after the PRACH slot 325-c, such that the PRACH slots 325 and the PUSCH slots 330 are interleaved. The PUSCH slot 330-c may include PUSCH occasions 315 PO #1 and PO #4 repeated in the time domain. In addition, the PO #1 may correspond to two PUSCH occasion repetitions 320 PO #2 and PO #3 in the frequency domain, and the PO #4 may correspond to two PUSCH occasion repetitions 320 PO #5 and PO #6 in the frequency domain. The PUSCH slot 330-d may include PUSCH occasions 315 PO #7 and PO #10 repeated in the time domain. In addition, the PO #7 may correspond to two PUSCH occasion repetitions 320 PO #8 and PO #9 in the frequency domain, and the PO #10 may correspond to two PUSCH occasion repetitions 320 PO #11 and PO #12 in the frequency domain. Each PUSCH occasion 315 may correspond to a DMRS resource.

In this way, the PUSCH slot 330-c and the PUSCH slot 330-d may include four MsgA PUSCH repetitions 340-b. The UE 115-a may transmit the one or more preambles and the one or more uplink payload transmissions (e.g., PUSCH transmissions), where the preamble and uplink payload transmissions may be interleaved based on the interleaved RACH and PUSCH occasions of the time-domain mapping pattern 300-b.

In some examples, the time-domain mapping patterns 300 may include MsgA preamble repetition resource mappings. That is, the network entity 105-a may map repetitions of the MsgA preambles to consecutive TDMed RACH occasions 305 within a single PRACH slot 325, or to consecutive TDMed RACH occasions 305 across multiple PRACH slots 325 (e.g., inter- or intra-slot repetitions). For example, the four MsgA preamble repetitions 335-a (corresponding to the RO #1, the RO #4, the RO #7, and the RO #10 of the time-domain mapping pattern 300-a) may be TDMed within the PRACH slot 325-a. Alternatively, the preamble repetitions 335-b (corresponding to the RO #1, the RO #4, the RO #7, and the RO #10 of the time-domain mapping pattern 300-b) may be TDMed across multiple PRACH slots 325, including the PRACH slot 325-b and the PRACH slot 325-c. Accordingly, the UE 115-a may transmit the one or more preambles in the one or more consecutive RACH occasions 215 of the time-domain mapping pattern 300-a that are TDMed with one or more PRACH slots 325.

Additionally, or alternatively, a time-domain mapping pattern 300 may specify MsgA PUSCH repetition resources with respect to a given MsgA preamble. That is, the network entity 105-a may map the MsgA PUSCH repetitions associated with a particular set of MsgA preamble repetitions to consecutive intra-slot or inter-slot TDMed PUSCH occasions 315. If the network entity 105-a uses consecutive inter-slot TDMed PUSCH occasions 315, the network entity 105-a may define priority orders between intra-slot and inter-slot TDMed PUSCH occasions 315. For example, a group of consecutive TDMed PUSCH occasions 315 may be taken as “bit-virtual” PUSCH occasions when considering the mapping priority orders, where PUSCH occasion ordering first may be based on PUSCH occasion groups, then the frequency-domain, then a DMRS-based domain, then the time-domain, irrespective of whether the PUSCH occasions 315 are intra-slot or inter-slot. The UE 115-a may transmit the one or more uplink payload transmissions in the one or more consecutive PUSCH occasions 315 that are TDMed in accordance with the time-domain mapping pattern 300-a, where the one or more uplink payload transmissions are associated with a subset of the one or more preambles.

FIG. 4 illustrates an example of time-domain mapping patterns 400 that supports random access and uplink shared channel occasion mapping patterns for random access procedures in accordance with one or more aspects of the present disclosure. In some examples, the time-domain mapping patterns 400 may implement aspects of the wireless communications systems 100 and 200 or may be implemented by aspects of the wireless communications systems 100 and 200. For example, a network entity 105-a may configure a time-domain mapping pattern 400-a and a time-domain mapping pattern 400-b to include one or more RACH occasions 405 and one or more PUSCH occasions 415 (e.g., uplink shared channel occasions). In some examples, the time-domain mapping patterns 400 may include examples of time-domain interleaving between the RACH occasions 405 and the PUSCH occasions 415, such as described with reference to FIG. 3.

The time-domain mapping patterns 400 may be based on an interleaving of the RACH occasions 405 including corresponding preambles and RACH occasion repetitions 410, and the PUSCH occasions 415 including corresponding uplink payload transmissions (e.g., PUSCH transmissions) and PUSCH occasion repetitions 420. For example, the network entity 105-a may configure the time-domain mapping patterns 400 such that the UE 115-a interleaves (e.g., alternates) the MsgA preamble repetitions and the MsgA PUSCH repetitions in the time domain based on interleaving the RACH occasions 405 and the PUSCH occasions 415 in the time domain.

Regarding the time-domain mapping pattern 400-a, the network entity 105-a may configure a set of twelve RACH occasions (also referred to herein as ROs) across the time domain, a frequency domain, and a preamble-based domain in PRACH slots 425. The twelve RACH occasions may include four RACH occasions 405 and eight RACH occasion repetitions 410. In addition, the network entity 105-a may configure a set of twelve PUSCH occasions (also referred to herein as POs) across the time domain, the frequency domain, and DMRS-based domain in PUSCH slots 430.

The time-domain mapping pattern 400-a may include a PRACH slot 425-a including a RACH occasion 405 RO #1 with RACH occasion repetitions 410 RO #2 and RO #3 in the frequency domain. In some examples, the RO #1 may correspond to two different preambles. Then, the time-domain mapping pattern 400-a may specify a PUSCH slot 430-a including a PUSCH occasion 415 PO #1 with PUSCH occasion repetitions 420 PO #2 and PO #3 in the frequency domain. The PO #1 may correspond to a single DMRS or other uplink payload transmission. As the PUSCH slot 430-a is subsequent to the PRACH slot 425-a, the PRACH slots 425 and the PUSCH slots 430 of the time-domain mapping pattern 400-a (and corresponding RACH occasions 405 and PUSCH occasions 415) are interleaved.

In addition, the time-domain mapping pattern 400-a may include a PRACH slot 425-b including a RACH occasion 405 RO #4 and RACH occasion repetitions 410 RO #5 and RO #6 in the frequency domain. Subsequent to the PRACH slot 425-b may be a PUSCH slot 430-b including a PUSCH occasion 415 PO #4 and PUSCH occasion repetitions 420 PO #5 and PO #6 in the frequency domain. In addition, the time-domain mapping pattern 400-a may include a PRACH slot 425-c including a RACH occasion 405 RO #7 and RACH occasion repetitions 410 RO #8 and RO #9 in the frequency domain. Subsequent to the PRACH slot 425-c may be a PUSCH slot 430-c including a PUSCH occasion 415 PO #7 and PUSCH occasion repetitions 420 PO #8 and PO #9 in the frequency domain. In some examples, the time-domain mapping pattern 400-a may include a PRACH slot 425-d including a RACH occasion 405 RO #10 and RACH occasion repetitions 410 RO #11 and RO #12 in the frequency domain. Subsequent to the PRACH slot 425-d may be a PUSCH slot 430-d including a PUSCH occasion 415 PO #10 and PUSCH occasion repetitions 420 PO #11 and PO #12 in the frequency domain. In this way, the PRACH slots 425 may include four MsgA preamble repetitions 435-a with respect to two different preambles, and the PUSCH slots 430 may include four MsgA PUSCH repetitions 440-a with respect to one PUSCH transmission. That is, the network entity 105-a may map the MsgA preamble repetitions 435-a with respect to the two different preambles to a same set of MsgA PUSCH repetitions 440-a. In addition, the UE 115-a may transmit interleaved preamble and PUSCH repetitions based on the interleaved RACH and PUSCH occasions.

Regarding the time-domain mapping pattern 400-b, the network entity 105-a may configure a set of twelve RACH occasions (also referred to herein as ROs) across the time domain, a frequency domain, and a preamble-based domain in PRACH slots 425. The twelve RACH occasions may include two RACH occasions 405 and ten RACH occasions repetitions 410. In addition, the network entity 105-a may configure a set of twelve PUSCH occasions (also referred to herein as POs) across the time domain, the frequency domain, and DMRS-based domain in PUSCH slots 430.

The time-domain mapping pattern 400-b may include a PRACH slot 425-e including a RACH occasion 405 RO #1 and RACH occasion repetitions 410 RO #2 and RO #3. In addition, the PRACH slot 425-e may include RACH occasion repetitions 410 RO #4, RO #5, and RO #6 in the time and frequency domains. In some examples, the RO #1 may correspond to two different preambles. In addition, the time-domain mapping pattern 400-b may specify a PUSCH slot 430-e including a PUSCH occasion 415 PO #1 and PUSCH occasion repetitions 420 PO #2 and PO #3. In addition, the PUSCH slot 430-e may include a PUSCH occasion 415 PO #4 and PUSCH occasion repetitions 420 PO #5 and PO #6 in the frequency domain. The PO #1 and the PO #4 may correspond to a single DMRS or other uplink payload transmission. As the PUSCH slot 430-e is consecutive to the PRACH slot 425-e, the PRACH slots 425 and the PUSCH slots 430 of the time-domain mapping pattern 400-b (and corresponding RACH occasions 405 and PUSCH occasions 415) are interleaved.

In addition, the time-domain mapping pattern 400-b may include a PRACH slot 425-f including a RACH occasion 405 RO #7 and RACH occasion repetitions 410 RO #8 and RO #9 in the frequency domain and RACH occasion repetitions 410 RO #10, RO #11, and RO #12 in the time and frequency domains. Subsequent to the PRACH slot 425-f, the time-domain mapping pattern 400-b may include a PUSCH slot 430-f including a PUSCH occasion 415 PO #7 and PUSCH occasion repetitions 420 PO #8 and PO #9 in the frequency domain and a PUSCH occasion 415 PO #10 and PUSCH occasion repetitions 420 PO #11 and PO #12 in the frequency domain. In this way, the PRACH slots 425 may correspond to two MsgA preamble repetitions 435-b with respect to two different preambles, and the PUSCH slots 430 may include four MsgA PUSCH repetitions 440-b with respect to one PUSCH transmission. That is, the network entity 105-a may map the MsgA preamble repetitions 435-b with respect to the two different preambles to a same set of MsgA PUSCH repetitions 440-b, where the RACH occasions 405 and the PUSCH occasions 415 may correspond to different repetition levels (e.g., 2 and 4, respectively). In addition, the UE 115-a may transmit interleaved preamble and PUSCH repetitions based on the interleaved RACH and PUSCH occasions.

FIG. 5 illustrates an example of a time-domain mapping pattern 500 that supports random access and uplink shared channel occasion mapping patterns for random access procedures in accordance with one or more aspects of the present disclosure. In some examples, the time-domain mapping pattern 500 may implement aspects of the wireless communications systems 100 and 200 or may be implemented by aspects of the wireless communications systems 100 and 200. For example, a network entity 105-a may configure the time-domain mapping pattern 500 to include one or more RACH occasions 505 and one or more PUSCH occasions 515 (e.g., uplink shared channel occasions). In some cases, the time-domain mapping pattern 500 may include repeated PUSCH occasions 515 for corresponding PUSCH transmission repetitions, however, may lack repeated RACH occasions 505 for corresponding preamble repetitions.

In some examples, the network entity 105-a may configure the time-domain mapping pattern 500 such that the UE 115-a may transmit a single MsgA preamble based on a single associated RACH occasion and multiple repetitions of MsgA PUSCH transmissions (e.g., the UE 115-a may refrain from repeating the MsgA preamble and may repeat the MsgA PUSCH transmissions) based on a set of associated PUSCH occasions.

The network entity 105-a may configure a RACH occasion 505 (also referred to herein as an RO) across a time domain, a frequency domain, and a preamble-based domain in a PRACH slot 525. For example, the PRACH slot 525 may include a RACH occasion 505 RO #1 with two RACH occasion repetitions 510 RO #2 and RO #3 in the frequency domain. The RACH occasion 505 RO #1 may be associated with two different preambles (e.g., the RACH occasion 505 RO #1 is shown twice representing the two different preambles).

In addition, the network entity 105-a may configure a set of PUSCH occasions 515 (also referred to herein as POs) across the time domain, the frequency domain, and a DMRS-based domain in a PUSCH slot 530-a and a PUSCH slot 530-b subsequent to the PRACH slot 525. Each PUSCH slot 530 may include a PUSCH occasions 515 and two PUSCH occasion repetitions 520. In the PUSCH slot 530-a, the PUSCH occasions 515 may include a PO #1 with PUSCH occasion repetitions 520 PO #2 and PO #3 in the frequency domain, and a PO #4 with PUSCH occasion repetitions 520 PO #5 and PO #6 in the frequency domain. In addition, the PUSCH slot 530-b may include a PUSCH occasion 515 PO #7 with PUSCH occasion repetitions 520 PO #8 and PO #9, and a PUSCH occasion 515 PO #10 with PUSCH occasion repetitions 520 PO #11 and PO #12. The UE 115-a may transmit a preamble 535 without repetition, and with respect to two different preambles, in the RACH occasion 505 RO #1 in the PRACH slot 525 before transmitting four PUSCH repetitions 540 in the PUSCH occasions 515 PO #1, PO #4, PO #7 and PO #10 in the PUSCH slot 530-a and the PUSCH slot 530-b. That is, the UE 115-a may transmit, in accordance with the time-domain mapping pattern, a first preamble of the one or more preambles in a first RACH occasion 505 and one or more uplink payload (e.g., PUSCH transmissions) in the one or more PUSCH occasions 515.

FIG. 6 illustrates an example of time-domain mapping patterns 600 that supports random access and uplink shared channel occasion mapping patterns for random access procedures in accordance with one or more aspects of the present disclosure. In some examples, the time-domain mapping patterns 600 may implement aspects of the wireless communications systems 100 and 200 or may be implemented by aspects of the wireless communications systems 100 and 200. For example, a network entity 105-a may configure a time-domain mapping pattern 600-a and a time-domain mapping pattern 600-b to each include one or more RACH occasions 605 and one or more PUSCH occasions 615 (e.g., uplink shared channel occasions). In some cases, the time-domain mapping patterns 600 may include repeated RACH occasions 605 for corresponding preamble repetitions, however, may lack repeated PUSCH occasions 615 for corresponding PUSCH transmission repetitions.

In some examples, the network entity 105-a may configure the time-domain mapping pattern 600-a such that the UE 115-a may transmit multiple MsgA preamble repetitions and a single MsgA PUSCH transmission. In some examples, the UE 115-a may repeat the MsgA preamble, and refrain from repeating the MsgA PUSCH, based on first repeating the MsgA preambles based on a set of RACH occasions 605 configured in the time-domain mapping pattern 600-a and then transmitting a single MsgA PUSCH based on a single PUSCH occasion 615 configured in the time-domain mapping pattern 600-a.

Regarding the time-domain mapping pattern 600-a, the network entity 105-a may configure a set of twelve RACH occasions (also referred to herein as ROs) across the time domain, a frequency domain, and a preamble-based domain in a PRACH slot 625-a. The twelve RACH occasions may include four RACH occasions 605 and eight RACH occasion repetitions 610. The PRACH slot 625-a may include RACH occasions 605 RO #1, RO #4, RO #7, and RO #10 repeated in the time domain. In addition, the RO #1 may correspond to two RACH occasion repetitions 610 RO #2 and RO #3 in the frequency domain, the RO #4 may correspond to two RACH occasion repetitions 610 RO #5 and RO #6 in the frequency domain, the RO #7 may correspond to two RACH occasion repetitions 610 RO #8 and RO #9 in the frequency domain, and the RO #10 may correspond to two RACH occasion repetitions 610 RO #11 and RO #12 in the frequency domain. Additionally, each RACH occasion 605 may correspond to two different preambles (e.g., two RACH occasions 605 RO #1 are shown representing the two different preambles). In this way, the PRACH slot 625-a may include four MsgA preamble repetitions 635-a with respect to two different preambles.

In addition, the network entity 105-a may configure a set of PUSCH occasions (also referred to herein as POs) across the time-domain, the frequency-domain, and a DMRS-based domain in a PUSCH slot 630-a. The PUSCH occasions may include a PUSCH occasions 615 and two PUSCH occasion repetitions 620. The PUSCH slot 630-a may include a PUSCH occasions 615 PO #1 with PUSCH occasion repetitions 620 PO #2 and PO #3 in the frequency domain. The UE 115-a may transmit four preamble repetitions in the RACH occasions 605 RO #1, RO #4, RO #7, and RO #10 in the PRACH slot 625-a before transmitting one PUSCH 640-a without repetition in PUSCH slot 630-a. That is, the UE 115-a may transmit, in accordance with the time-domain mapping pattern 600-a, one or more preambles in the one or more RACH occasions 605 RO #1, RO #4, RO #7, and RO #10 and a first uplink payload (e.g., PUSCH) transmission in the PUSCH occasion 615 PO #1.

Alternatively, the network entity 105-a may configure the time-domain mapping pattern 600-b such that the UE 115-a may transmit a single MsgA preamble, followed by a single MsgA PUSCH, followed by one or more additional MsgA preamble repetitions. Regarding the time-domain mapping pattern 600-b, the network entity 105-a may configure a set of twelve RACH occasions (also referred to herein as ROs) across the time domain, a frequency domain, and a preamble-based domain in a PRACH slot 625-b and a PRACH slot 625-c. In the PRACH slot 625-b, the RACH occasion 605 RO #1 may correspond to two RACH occasion repetitions 610 RO #2 and RO #3 in the frequency domain. Subsequent to the PRACH slot 625-b, the network entity 105-a may configure a set of PUSCH occasions (also referred to herein as POs) across the time domain, the frequency domain, and a DMRS-based domain in a PUSCH slot 630-b. The PUSCH slot 630-b may include a PUSCH occasion 615 PO #1 with PUSCH occasion repetitions 620 PO #2 and PO #3 in the frequency domain.

Additionally, subsequent to the PUSCH slot 630-b, the network entity 105-a may configure a set of RACH occasions in the PRACH slot 625-c. In the PRACH slot 625-c, the RACH occasion 605 RO #4 may correspond to two RACH occasion repetitions 610 RO #5 and RO #6 in the frequency domain, the RACH occasion 605 #7 may correspond to two RACH occasion repetitions 610 RO #8 and RO #9, and the RACH occasion 605 RO #10 may correspond to two RACH occasion repetitions 610 RO #11 and RO #12 in the frequency domain. As such, the UE 115-a may transmit one preamble repetition in the RACH occasions 605 RO #1 in the PRACH slot 625-b, a PUSCH 640-b without repetition in the PUSCH slot 630-b, and then three additional preamble repetitions in the RACH occasions 605 RO #4, RO #7, and RO #10 in the PRACH slot 625-c, such that the PUSCH 640-b is between preamble repetitions 635-b.

FIG. 7 illustrates an example of a time-domain mapping pattern 700 that supports random access and uplink shared channel occasion mapping patterns for random access procedures in accordance with one or more aspects of the present disclosure. In some examples, the time-domain mapping pattern 700 may implement aspects of the wireless communications systems 100 and 200 or may be implemented by aspects of the wireless communications systems 100 and 200. For example, a network entity 105-a may configure a time-domain mapping pattern 700 to include one or more RACH occasions the one or more PUSCH occasions (e.g., uplink shared channel occasions), where the network entity 105-a may multiplex the RACH occasions and the PUSCH occasions among different repetition levels.

In some examples, a UE 115-a may identify one or more RACH occasions and one or more PUSCH occasions for joint MsgA preamble and MsgA PUSCH transmissions based on configurations indicated from the network entity 105-a. For example, the UE 115-a may receive control signaling indicating the time-domain mapping pattern 700, which may include one or more RACH occasions and one or more PUSCH occasions for transmission of a random access message of a RACH procedure. That is, the random access message (e.g., MsgA) may be a first transmission of a 2-step RACH procedure that includes preamble and PUSCH (e.g., uplink payload) transmissions. The network entity 105-a may transmit the control signaling via RMSI or UE-specific RRC signaling.

In some cases, the network entity 105-a may configure different repetition levels across different sets of RACH occasion-PUSCH occasion groupings. For example, RACH occasion-PUSCH occasion mappings associated with different repetition levels may be TDMed, FDMed, or CDMed based on at least a preamble sequence, a DMRS port or sequence, or both. That is, the UE 115-a may receive the control signaling indicating the time-domain mapping pattern 700 between the one or more RACH occasions and the one or more PUSCH occasions, the time-domain mapping pattern 700 based on a set of joint preamble and uplink payload (PUSCH) transmission repetitions associated with one or more repetition levels 735, and where the set of joint preamble and uplink payload transmission repetitions are TDMed, FDMed, or CDMed.

In some cases, for CDMed RACH occasion-PUSCH occasion mappings, the network entity 105-a may use a same RACH occasion-PUSCH occasion pair for different repetition levels 735. That is, for the set of joint preamble and uplink payload transmission repetitions that is CDMed, a first joint payload and uplink payload transmission repetition may be associated with one or more repetition levels 735. For example, the time-domain mapping pattern 700 may include a repetition level 735-a, a repetition level 735-b, and a repetition level 735-c, where each repetition level 735 may correspond to different mapped RACH occasion-PUSCH occasion pairs. In some cases, the network entity 105-a may configure, and the UE 115-a may select to use, a given repetition level 735 and RACH occasion-PUSCH occasion pair based on at least two RSRP thresholds, a first threshold Th₁ and a second threshold Th₂, predefined or configured by the network entity 105-a.

Each repetition level 735 may be associated with different repetitions of RACH occasions (also referred to herein as ROs) and PUSCH occasions (also referred to herein as POs), which may be TDMed sequentially. For example, the RACH occasion and PUSCH occasions may include first RO-PO pairs 705 (e.g., RO #1 and PO #1), second RO-PO pairs 710 (e.g., RO #2 and PO #2), third RO-PO pairs 715 (e.g., RO #3 and PO #3), and fourth RO-PO pairs 720 (e.g., RO #4 and PO #4). For each repetition level 735, the UE 115-a may transmit one or more preambles using RACH occasions in a PRACH slot 725 and one or more uplink payload transmissions using PUSCH occasions and corresponding DMRS resources in a PUSCH slot 730. For example, the UE 115-a may transmit a RACH occasion RO #1 of the first RO-PO pair 705 in a PRACH slot 725-a and a PUSCH occasion PO #1 in a PUSCH slot 730-a. In addition, the UE 115-a may transmit one or more RACH occasions RO #2, RO #3, and RO #4 in a PRACH slot 725-b, a PRACH slot 725-c, and a PRACH slot 725-d, respectively, and one or more PUSCH occasions PO #2, PO #3, and PO #4 in a PUSCH slot 730-b, a PUSCH slot 730-c, and a PUSCH slot 730-d, respectively.

The UE may transmit different preamble and PUSCH repetitions according to a repetition level 735 based on comparing a measured RSRP to the one or more RSRP thresholds. For example, if a measured RSRP is greater than the second threshold (e.g., RSRP>Th₂), the UE 115-a may use a preamble #1-DMRS #1 together with the first RO-PO pair 705 (e.g., RO #1-PO #1), the second RO-PO pair 710 (e.g., RO #2-PO #2), the third RO-PO pair 715 (e.g., RO #3-PO #3), or the fourth RO-PO pair 720 (e.g., RO #4-PO #4). That is, the UE 115-a may transmit two preambles in RO #1 and one DMRS resource in PO #1 based on the first RO-PO pair 705 associated with the repetition level 735-a. The second RO-PO pair 710, the third RO-PO pair 715, and the fourth RO-PO pair 720 may be repetitions of the first RO-PO pair 705, where the network entity 105-a may map repetitions with respect to two different MsgA preambles to a same set of MsgA PUSCH repetitions (e.g., the two preambles associated with RO #2 correspond to a PUSCH associated with PO #2). In this way, the UE 115-a may transmit four preamble repetitions and four PUSCH repetitions in corresponding RO-PO pairs at the repetition level 735-a (e.g., a repetition level of 4). The RACH occasions and the PUSCH occasions associated with the RO-PO pairs of the repetition level 735-a may be interleaved as described herein with reference to FIGS. 3 and 4.

If a measured RSRP is greater than the first threshold and less than the second threshold (e.g., Th₁<RSRP<Th₂), the UE 115-a may use a preamble #2-DMRS #2 together with the first RO-PO pair 705 (e.g., RO #1-PO #1), the second RO-PO pair 710 (e.g., RO #2-PO #2), the third RO-PO pair 715 (e.g., RO #3-PO #3), or the fourth RO-PO pair 720 (e.g., RO #4-PO #4), or a preamble #3-DMRS #3 together with the second RO-PO pair 710 or the third RO-PO pair 715. That is, the UE 115-a may transmit two preambles in RO #1 and one DMRS resource in PO #1 based on the first RO-PO pair 705 associated with the repetition level 735-b, where the preambles and DMRS resource for the repetition level 735-b are different than that of the repetition level 735-a. The second RO-PO pair 710, the third RO-PO pair 715, and the fourth RO-PO pair 720 may be repetitions of the first RO-PO pair 705, where the network entity 105-a may map repetitions with respect to two different MsgA preambles to a same set of MsgA PUSCH repetitions (e.g., the two preambles associated with RO #2 correspond to a PUSCH associated with PO #2). In this way, the UE 115-a may transmit two preamble repetitions and two PUSCH repetitions in corresponding RO-PO pairs at the repetition level 735-b (e.g., a repetition level of 2). The RACH occasions and the PUSCH occasions associated with the RO-PO pairs of the repetition level 735-b may be interleaved as described herein with reference to FIGS. 3 and 4.

In addition, two RACH occasion and PUSCH occasion repetitions associated with the repetition level 735-b may be linked with a given RAR window. For example, the first RO-PO pair 705 and the second RO-PO pair 710 may be two repetitions linked with a first RAR window (e.g., RAR-window #1), the second RO-PO pair 710 and the third RO-PO pair 715 may be linked with a second RAR window (e.g., RAR-window #2), and the third RO-PO pair 715 and the fourth RO-PO pair 720 may be linked with a third RAR window (e.g., RAR-window #3). Using the repetition level 735-b, the UE 115-a may select which set of two repetitions to use.

In some cases, the network entity 105-a may configure when the UE 115-a is to receive an RAR message. The RAR message may be a MsgB (e.g., a second transmission of the two-step RACH procedure), and a MsgB RAR window may begin depending on the preamble and PUSCH repetitions as described herein. The network entity 105-a may configure or determine a beginning of a MsgB RAR window based on a last symbol of a last MsgA preamble or MsgA PUSCH repetition of all of the MsgA preamble and PUSCH repetitions associated with the same repetition level. For example, the UE 115-a may select the first RO-PO pair 705 and the second RO-PO pair 710 of the repetition level 735-b, which may lead to an RAR window #1 beginning at a first symbol (e.g., symbol #1). Alternatively, the UE 115-a may select the second RO-PO pair 710 and the third RO-PO pair 715, which may lead to the RAR window #2 starting at a second symbol (e.g., symbol #2), or the UE 115-a may select the third RO-PO pair 715 and the fourth RO-PO pair 720, which may lead to an RAR window #3 beginning at a third symbol (e.g., symbol #3), where the first symbol is earlier than the second symbol, and where the second symbol is earlier than the third symbol. In this way, the UE 115-a may receive an RAR message from the network entity 105-a in a RAR window, where a beginning of the RAR window is based on a last symbol of a last preamble of the one or more preambles or a last uplink payload transmission of the one or more uplink payload transmissions associated with a repetition level 735.

If a measured RSRP is less than the first threshold (e.g., RSRP<Th₁), the UE 115-a may use a preamble #3-DMRS #3 together with the first RO-PO pair 705 (e.g., RO #1-PO #1), the second RO-PO pair 710 (e.g., RO #2-PO #2), the third RO-PO pair 715 (e.g., RO #3-PO #3), or the fourth RO-PO pair 720 (e.g., RO #4-PO #4). That is, the UE 115-a may transmit two preambles in RO #1 and one DMRS resource in PO #1 based on the first RO-PO pair 705 associated with the repetition level 735-c, where the preambles and DMRS resource for the repetition level 735-c are different than that of the repetition level 735-a and the repetition level 735-a. The second RO-PO pair 710, the third RO-PO pair 715, and the fourth RO-PO pair 720 may be repetitions of the first RO-PO pair 705, where the network entity 105-a may map repetitions with respect to two different MsgA preambles to a same set of MsgA PUSCH repetitions (e.g., the two preambles associated with RO #2 correspond to a PUSCH associated with PO #2). In this way, the UE 115-a may transmit a preamble and PUSCH without repetitions in corresponding RO-PO pairs at the repetition level 735-c (e.g., a repetition level of 1). The RACH occasions and the PUSCH occasions associated with the RO-PO pairs of the repetition level 735-c may be interleaved as described herein with reference to FIGS. 3 and 4. In this way, the network entity 105-a may configure the UE 115-a with particular RO-PO pairs and corresponding preambles and DMRS resources depending on how many repetitions the UE 115-a may choose to transmit.

FIG. 8 illustrates an example of time-domain mapping patterns 800 that supports random access and uplink shared channel occasion mapping patterns for random access procedures in accordance with one or more aspects of the present disclosure. In some examples, the time-domain mapping patterns 800 may implement aspects of the wireless communications systems 100 and 200 or may be implemented by aspects of the wireless communications systems 100 and 200. For example, a network entity 105-a may configure a time-domain mapping pattern 800-a or a time-domain mapping pattern 800-b to include one or more RACH occasions and one or more PUSCH occasions (e.g., uplink shared channel occasions), where the network entity 105-a may multiplex the RACH occasions and the PUSCH occasions among different repetition levels.

As described herein, a UE 115-a may identify one or more RACH occasions and one or more PUSCH occasions for joint MsgA preamble and MsgA PUSCH transmissions based on configurations indicated from the network entity 105-a. For example, the UE 115-a may receive control signaling indicating a time-domain mapping pattern 800, which may include one or more RACH occasions and one or more PUSCH occasions for transmission of a random access message of a RACH procedure. That is, the random access message (e.g., MsgA) may be a first transmission of a 2-step RACH procedure that includes preamble and PUSCH (e.g., uplink payload) transmissions. The network entity 105-a may transmit the control signaling via RMSI or UE-specific RRC signaling.

In some cases, the network entity 105-a may configure different repetition levels across different sets of RACH occasion-PUSCH occasion groupings. For example, RACH occasion-PUSCH occasion mappings associated with different repetition levels may be TDMed, FDMed, or CDMed based on at least a preamble sequence, a DMRS port or sequence, or both. In some cases, for CDMed RACH occasion-PUSCH occasion mappings, the network entity 105-a may use a same RACH occasion-PUSCH occasion pair for different repetition levels 835. That is, for the set of joint preamble and uplink payload transmission repetitions that is CDMed, a first joint payload and uplink payload transmission repetition may be associated with one or more repetition levels 835.

The time-domain mapping pattern 800-a and the time-domain mapping pattern 800-b may be examples of RACH occasion and PUSCH occasion mapping based on preamble repetitions only or PUSCH (e.g., uplink payload transmission) repetitions only. The time-domain mapping pattern 800-a may include a repetition level 835-a, a repetition level 835-b, and a repetition level 835-c, where each repetition level 835 may correspond to different mapped RACH occasion-PUSCH occasion pairs. In some cases, the network entity 105-a may configure, and the UE 115-a may select to use, a given repetition level 835 and RACH occasion-PUSCH occasion pair based on at least two RSRP thresholds, a first threshold Th₁ and a second threshold Th₂, predefined or configured (e.g., signaled) by the network entity 105-a.

Each repetition level 835 may be associated with different repetitions of RACH occasions (also referred to herein as ROs) and PUSCH occasions (also referred to herein as POs), which may be TDMed sequentially. For example, the RACH occasion and PUSCH occasions may include first RO-PO pairs 805 (e.g., RO #1 and PO #1), second RO-PO pairs 810 (e.g., RO #2 and PO #2), third RO-PO pairs 815 (e.g., RO #3 and PO #3), and fourth RO-PO pairs 820 (e.g., RO #4 and PO #4). For each repetition level 835, the UE 115-a may transmit one or more preambles using RACH occasions in a PRACH slot 825, and in some cases, one or more uplink payload transmissions using PUSCH occasions and corresponding DMRS resources in a PUSCH slot 830. In the example of the time-domain mapping pattern 800-a, the repetition levels 835 may be based on only preamble repetitions (and single PUSCH transmissions). For example, the UE 115-a may transmit a RACH occasion RO #1 of the first RO-PO pair 805 in a PRACH slot 825-a and a PUSCH occasion PO #1 in a PUSCH slot 830-a. In addition, the UE 115-a may transmit one or more RACH occasions RO #2, RO #3, and RO #4 in a PRACH slot 825-b, a PRACH slot 825-c, and a PRACH slot 825-d, respectively. That is, the UE 115-a may transmit preamble repetitions and a PUSCH without repetitions based on the time-domain mapping pattern 800-a including RACH occasion repetitions and a PUSCH occasion without repetitions.

The UE may transmit different preamble and PUSCH repetitions according to a repetition level 835 based on comparing a measured RSRP to the one or more RSRP thresholds. For example, if a measured RSRP is greater than the second threshold (e.g., RSRP>Th₂), the UE 115-a may use a preamble #1-DMRS #1 together with the first RO-PO pair 805 (e.g., RO #1-PO #1). That is, the UE 115-a may transmit two preambles in RO #1 and one DMRS resource in PO #1 based on the first RO-PO pair 805 associated with the repetition level 835-a. The network entity 105-a may map repetitions with respect to two different MsgA preambles to a same set of MsgA PUSCH repetitions (e.g., the two preambles associated with RO #1 correspond to a PUSCH associated with PO #1). In this way, the UE 115-a may transmit one preamble and one PUSCH repetition in a corresponding RO-PO pair at the repetition level 835-a (e.g., a repetition level of 1).

If a measured RSRP is greater than the first threshold and less than the second threshold (e.g., Th₁<RSRP<Th₂), the UE 115-a may use a preamble #2-DMRS #2 together with the first RO-PO pair 805 (e.g., RO #1-PO #1), and a RACH occasion of the second RO-PO pair 810 (e.g., RO #2). That is, the UE 115-a may transmit two preambles in RO #1 and one DMRS resource in PO #1 based on the first RO-PO pair 805 associated with the repetition level 835-b, where the preambles and DMRS resource for the repetition level 835-b are different than that of the repetition level 835-a. The second RO-PO pair 810 may a repetition of the first RO-PO pair 805, where the network entity 105-a may map repetitions with respect to two different MsgA preambles to a same set of MsgA PUSCH repetitions (e.g., the two preambles associated with RO #1 correspond to a PUSCH associated with PO #1). In this way, the UE 115-a may transmit two preamble repetitions and one PUSCH repetition in corresponding RO-PO pairs at the repetition level 835-b (e.g., a repetition level of 2).

If a measured RSRP is less than the first threshold (e.g., RSRP<Th₁), the UE 115-a may use a preamble #3-DMRS #3 together with the first RO-PO pair 805 (e.g., RO #1-PO #1), the second RO-PO pair 810 (e.g., RO #2-PO #2), the third RO-PO pair 815 (e.g., RO #3-PO #3), or the fourth RO-PO pair 820 (e.g., RO #4-PO #4). That is, the UE 115-a may transmit two preambles in RO #1 and one DMRS resource in PO #1 based on the first RO-PO pair 805 associated with the repetition level 835-c, where the preambles and DMRS resource for the repetition level 835-c are different than that of the repetition level 835-a and the repetition level 835-b. The second RO-PO pair 810, the third RO-PO pair 815, and the fourth RO-PO pair 820 may be repetitions of the first RO-PO pair 805, where the network entity 105-a may map repetitions with respect to two different MsgA preambles to a same set of MsgA PUSCH repetitions (e.g., the two preambles associated with RO #1 correspond to a PUSCH associated with PO #1), and the UE 115-a may repeat only the RACH occasions of each RO-PO pair. In this way, the UE 115-a may transmit a four preamble repetitions and a PUSCH without repetitions in corresponding RO-PO pairs at the repetition level 835-c (e.g., a repetition level of 4). Accordingly, the network entity 105-a may configure the UE 115-a with particular RO-PO pairs and corresponding preambles and DMRS resources depending on how many preamble and PUSCH repetitions the UE 115-a may choose to transmit.

In addition, each repetition level 835 may be associated with a RAR window. For example, the single RACH occasions associated with the repetition level 835-a may be linked with an RAR window #1, the two RACH occasion repetitions associated with the repetition level 835-b may be linked with an RAR window #2, and the four RACH occasion repetitions associated with the repetition level 835-c may be linked with an RAR window #3.

Alternatively, in the example of the time-domain mapping pattern 800-b, the repetition levels 835 may be based on only PUSCH repetitions (and single preamble transmissions). For example, the UE 115-a may transmit a RACH occasion RO #1 of the first RO-PO pair 805 in a PRACH slot 825-e and a PUSCH occasion PO #1 in a PUSCH slot 830-b. In addition, the UE 115-a may transmit one or more PUSCH occasions PO #2, PO #3, and PO #4 in a PUSCH slot 830-c, a PUSCH slot 830-d, and a PUSCH slot 830-e, respectively. That is, the UE 115-a may transmit a preamble without repetitions and multiple PUSCH repetitions based on the time-domain mapping pattern 800-b including PUSCH occasion repetitions and a RACH occasion without repetitions.

The UE may transmit different preamble and PUSCH repetitions according to a repetition level 835 based on comparing a measured RSRP to the one or more RSRP thresholds. For example, if a measured RSRP is greater than the second threshold (e.g., RSRP>Th₂), the UE 115-a may use a preamble #1-DMRS #1 together with the first RO-PO pair 805 (e.g., RO #1-PO #1). That is, the UE 115-a may transmit two preambles in RO #1 and one DMRS resource in PO #1 based on the first RO-PO pair 805 associated with a repetition level 835-d. The network entity 105-a may map repetitions with respect to two different MsgA preambles to a same set of MsgA PUSCH repetitions (e.g., the two preambles associated with RO #1 correspond to a PUSCH associated with PO #1). In this way, the UE 115-a may transmit one preamble and one PUSCH repetition in a corresponding RO-PO pair at the repetition level 835-d (e.g., a repetition level of 1).

If a measured RSRP is greater than the first threshold and less than the second threshold (e.g., Th₁<RSRP<Th₂), the UE 115-a may use a preamble #2-DMRS #2 together with the first RO-PO pair 805 (e.g., RO #1-PO #1), and a PUSCH occasion of the second RO-PO pair 810 (e.g., PO #2). That is, the UE 115-a may transmit two preambles in RO #1 and one DMRS resource in PO #1 based on the first RO-PO pair 805 associated with a repetition level 835-e, where the preambles and DMRS resource for the repetition level 835-e are different than that of the repetition level 835-d. The second RO-PO pair 810 may a repetition of the first RO-PO pair 805, where the network entity 105-a may map repetitions with respect to two different MsgA preambles to a same set of MsgA PUSCH repetitions (e.g., the two preambles associated with RO #1 correspond to a PUSCH associated with PO #1). In this way, the UE 115-a may transmit two PUSCH repetitions and one preamble repetition in corresponding RO-PO pairs at the repetition level 835-e (e.g., a repetition level of 2).

If a measured RSRP is less than the first threshold (e.g., RSRP<Th₁), the UE 115-a may use a preamble #3-DMRS #3 together with the first RO-PO pair 805 (e.g., RO #1-PO #1), the second RO-PO pair 810 (e.g., RO #2-PO #2), the third RO-PO pair 815 (e.g., RO #3-PO #3), or the fourth RO-PO pair 820 (e.g., RO #4-PO #4). That is, the UE 115-a may transmit two preambles in RO #1 and one DMRS resource in PO #1 based on the first RO-PO pair 805 associated with a repetition level 835-f, where the preambles and DMRS resource for the repetition level 835-f are different than that of the repetition level 835-d and the repetition level 835-e. The second RO-PO pair 810, the third RO-PO pair 815, and the fourth RO-PO pair 820 may be repetitions of the first RO-PO pair 805, where the network entity 105-a may map repetitions with respect to two different MsgA preambles to a same set of MsgA PUSCH repetitions (e.g., the two preambles associated with RO #1 correspond to a PUSCH associated with PO #1), and the UE 115-a may repeat only the RACH occasions of each RO-PO pair. In this way, the UE 115-a may transmit four PUSCH repetitions and a preamble without repetitions in corresponding RO-PO pairs at the repetition level 835-f (e.g., a repetition level of 4). Accordingly, the network entity 105-a may configure the UE 115-a with particular RO-PO pairs and corresponding preambles and DMRS resources depending on how many preamble and PUSCH repetitions the UE 115-a may choose to transmit.

In addition, each repetition level 835 may be associated with a RAR window. For example, the single RACH occasions associated with the repetition level 835-d may be linked with an RAR window #1, the two RACH occasion repetitions associated with the repetition level 835-e may be linked with an RAR window #2, and the four RACH occasion repetitions associated with the repetition level 835-f may be linked with an RAR window #3.

FIG. 9 illustrates an example of time-domain mapping patterns 900 that supports random access and uplink shared channel occasion mapping patterns for random access procedures in accordance with one or more aspects of the present disclosure. In some examples, the time-domain mapping patterns 900 may implement aspects of the wireless communications systems 100 and 200 or may be implemented by aspects of the wireless communications systems 100 and 200. For example, a network entity 105-a may configure a time-domain mapping pattern 900-a or a time-domain mapping pattern 900-b to include one or more RACH occasions and one or more PUSCH occasions (e.g., uplink shared channel occasions), where the network entity 105-a may multiplex the RACH occasions and the PUSCH occasions among different SSBs.

As described herein with reference to FIGS. 7 and 8, a network entity 105-a may multiplex different RACH occasion and PUSCH occasion pairs for different repetition levels. Additionally, or alternatively, the network entity 105-a may multiplex RACH occasion and PUSCH occasion pairs for different SSBs. In some examples, different joint MsgA preamble and MsgA PUSCH repetitions may be associated with a same SSB or different SSBs for a given repetition level. In some cases, the network entity 105-a may transmit a set of joint preamble and uplink payload transmission (e.g., PUSCH) repetitions, wherein the set of joint preamble and uplink payload transmission repetitions is associated with one or more SSBs for a given repetition level.

The network entity 105-a may configure the time-domain mapping pattern 900-a based on different joint MsgA preamble and MsgA PUSCH repetitions being associated with the same SSB. For a given repetition level, the UE 115-a may select a RACH occasion-PUSCH occasion mapping based on identifying a single strongest SSB and selecting the RACH occasion-PUSCH occasion mapping from one or more RO-PO pairs associated with that SSB. For example, the UE 115-a may identify a strongest SSB RSRP, identify a repetition level (e.g., 2), identify a single strongest SSB (e.g., the SSB #1), and randomly choose from the first RO-PO pair 905 (e.g., RO #1-PO #1), one of the second RO-PO pair 910 (e.g., RO #2-PO #2) or the third RO-PO pair 915 (e.g., RO #3-PO #3), or the fourth RO-PO pair 920 (e.g., RO #4-PO #4).

The network entity 105-a may configure the time-domain mapping pattern 900-b based on different joint MsgA preamble and MsgA PUSCH repetitions being associated with different SSBs. For a given repetition level, the UE 115-a may select a RACH occasion-PUSCH occasion mapping based on one or more SSBs with respect to one or more highest identified (or measured) RSRPs. That is, the UE 115-a may select a first joint preamble and uplink payload transmission repetition of the set of joint preamble and uplink payload transmission repetitions based on an SSB associated with the first joint preamble and uplink payload transmission repetition corresponding to a highest identified RSRP. In some examples, some quantity of SSBs associated with the highest identified RSRP is associated with a repetition level.

Each repetition level may be associated with different repetitions of RACH occasions (also referred to herein as ROs) and PUSCH occasions (also referred to herein as POs), which may be TDMed sequentially. For example, the RACH occasion and PUSCH occasions may include first RO-PO pairs 905 (e.g., RO #1 and PO #1), second RO-PO pairs 910 (e.g., RO #2 and PO #2), third RO-PO pairs 915 (e.g., RO #3 and PO #3), and fourth RO-PO pairs 920 (e.g., RO #4 and PO #4). For each repetition level, the UE 115-a may transmit one or more preambles using RACH occasions in a PRACH slot and one or more uplink payload transmissions using PUSCH occasions and corresponding DMRS resources in a PUSCH slot. In addition, each RO-PO pair may be associated with an SSB. For example, the first RO-PO pair 905 may be associated with an SSB #1, the second RO-PO pair 910 may be associated with an SSB #2, the third RO-PO pair 915 may be associated with an SSB #3, and the fourth RO-PO pair 920 may be associated with an SSB #4.

One or more UEs 115 may identify one or more RACH occasion-PUSCH occasion repetitions (e.g., MsgA repetitions). For example, a first UE (e.g., UE #1), a second UE (e.g., UE #2), and a third UE (e.g., UE #3) may each identify two repetitions for MsgA. In some examples, each UE 115 may identify a strongest measured SSB RSRP, identify a repetition level, and then identify corresponding strongest SSBs. For example, based on a repetition level of 2, the first UE may identify that the strongest two SSBs are SSB #1 and SSB #2, and thus the first UE may select the first RO-PO pair 905 (e.g., RO #1-PO #1) and the second RO-PO pair 910 (e.g., RO #2-PO #2) for transmitting the two MsgA repetitions using two preambles and one DMRS (e.g., preamble #1/#2 and DMRS #1). Additionally, the second UE may identify that the strongest two SSBs are SSB #2 and SSB #3, and thus the first UE may select the second RO-PO pair 910 (e.g., RO #2-PO #2) and the third RO-PO pair 915 (e.g., RO #3-PO #3) for transmitting the two MsgA repetitions using two preambles and one DMRS (e.g., preamble #3/#4 and DMRS #2). In some examples, the third UE may identify that the strongest two SSBs are SSB #3 and SSB #4, and thus the first UE may select the third RO-PO pair 915 (e.g., RO #3-PO #3) and the fourth RO-PO pair 920 (e.g., RO #4-PO #4) for transmitting the two MsgA repetitions using two preambles and one DMRS (e.g., preamble #1/#2 and DMRS #1).

In some examples, a quantity of the identified different strongest SSBs may be associated with the repetition levels (or the RSRP level of the strongest SSB). For example, the first UE (that measured a strongest SSB's RSRP>a second threshold Th₂) may only identify a single strongest SSB and its associated RACH occasion-PUSCH occasion mappings (including the preambles and the DMRS to be used). In addition, the second UE (that measured a strongest SSB's RSRP: first RSRP threshold Th₁<RSRP<Th₂) may only identify two strongest SSBs and their associated RACH occasion-PUSCH occasion mappings (including the preambles and the DMRSs to be used). In some cases, the third UE (that measured a strongest SSB's RSRP<Th₁ may only identify four strongest SSBs and their associated RACH occasion-PUSCH occasion mappings (including the preambles and the DMRSs to be used).

In some cases, the UE 115-a may use the time-domain mapping pattern 900-b to transmit preamble and PUSCH repetitions based on one or more SSBs. In some examples, the UE 115-a may repeat only the preambles. In this way, the first UE may identify that the strongest two SSBs are SSB #1 and SSB #2, and thus the first UE may select the first RO-PO pair 905 (e.g., RO #1-PO #1) and the RACH occasion of the second RO-PO pair 910 (e.g., RO #2) for transmitting the two MsgA repetitions using two preambles and one DMRS (e.g., preamble #1/#2 and DMRS #1). Additionally, the second UE may identify that the strongest two SSBs are SSB #2 and SSB #3, and thus the first UE may select the second RO-PO pair 910 (e.g., RO #2-PO #2) and the RACH occasion of the third RO-PO pair 915 (e.g., RO #3) for transmitting the two MsgA repetitions using two preambles and one DMRS (e.g., preamble #3/#4 and DMRS #2). In some examples, the third UE may identify that the strongest two SSBs are SSB #3 and SSB #4, and thus the first UE may select the third RO-PO pair 915 (e.g., RO #3-PO #3) and the RACH occasion of the fourth RO-PO pair 920 (e.g., RO #4) for transmitting the two MsgA repetitions using two preambles and one DMRS (e.g., preamble #1/#2 and DMRS #1).

Alternatively, the UE 115-a may repeat only the PUSCH transmissions. In this way, the first UE may identify that the strongest two SSBs are SSB #1 and SSB #2, and thus the first UE may select the first RO-PO pair 905 (e.g., RO #1-PO #1) and the PUSCH occasion of the second RO-PO pair 910 (e.g., PO #2) for transmitting the two MsgA repetitions using two preambles and one DMRS (e.g., preamble #1/#2 and DMRS #1). Additionally, the second UE may identify that the strongest two SSBs are SSB #2 and SSB #3, and thus the first UE may select the second RO-PO pair 910 (e.g., RO #2-PO #2) and the PUSCH occasion of the third RO-PO pair 915 (e.g., PO #3) for transmitting the two MsgA repetitions using two preambles and one DMRS (e.g., preamble #3/#4 and DMRS #2). In some examples, the third UE may identify that the strongest two SSBs are SSB #3 and SSB #4, and thus the first UE may select the third RO-PO pair 915 (e.g., RO #3-PO #3) and the PUSCH occasion of the fourth RO-PO pair 920 (e.g., PO #4) for transmitting the two MsgA repetitions using two preambles and one DMRS (e.g., preamble #1/#2 and DMRS #1).

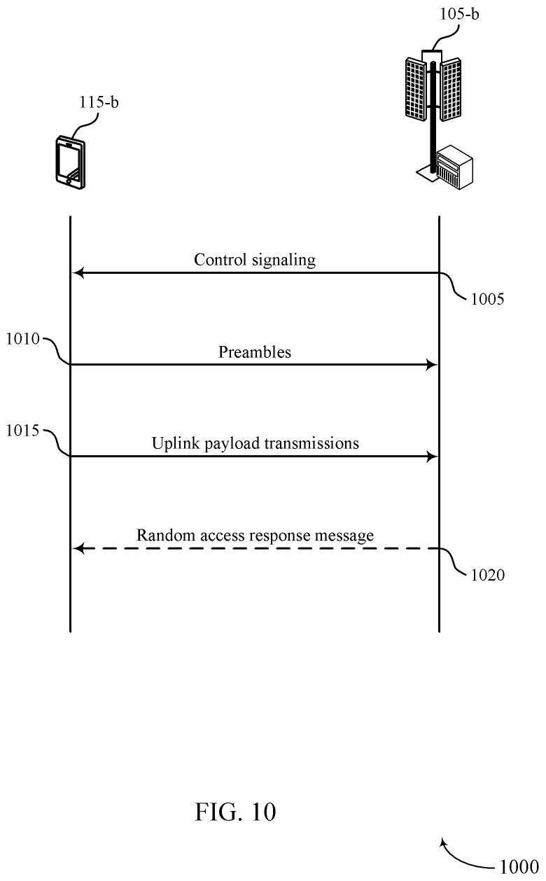

FIG. 10 illustrates an example of a process flow 1000 that supports random access and uplink shared channel occasion mapping patterns for random access procedures in accordance with one or more aspects of the present disclosure. The process flow 1000 may implement aspects of wireless communications systems 100 and 200, or may be implemented by aspects of the wireless communications system 100 and 200. For example, the process flow 1000 may illustrate operations between a UE 115-b and a network entity 105-b, which may be examples of corresponding devices described herein. In the following description of the process flow 1000, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 1000, and other operations may be added to the process flow 1000.

At 1005, the UE 115-b may receive, from the network entity 105-b, control signaling indicating a time-domain mapping pattern between one or more RACH occasions and one or more uplink shared channel (e.g., PUSCH) occasions for transmission of a RACH message of a RACH procedure. In some examples, the network entity 105-a may configure the time-domain mapping pattern based on repeating RACH occasions and then uplink shared channel occasions consecutively, or based on interleaving the RACH and uplink shared channel occasions. In some examples, the time-domain mapping pattern may be based on one or more repetition levels, SSBs, or both associated with joint preamble and uplink payload transmission repetitions.

At 1010, the UE 115-b may transmit, to the network entity 105-b and in the one or more RACH occasions in accordance with the time-domain mapping pattern, one or more preambles of the RACH message of the RACH procedure. For example, the UE 115-a may transmit multiple preamble (e.g., MsgA preamble) repetitions based on the time-domain mapping pattern including multiple RACH occasion repetitions.

At 1015, the UE 115-b may transmit, to the network entity 105-b and in the one or more uplink shared channel occasions in accordance with the time-domain mapping pattern, one or more uplink payload transmissions of the RACH message of the RACH procedure. For example, the UE 115-a may transmit multiple PUSCH (e.g., MsgA PUSCH) repetitions based on the time-domain mapping pattern including multiple uplink shared channel occasion repetitions.

At 1020, the UE 115-b may receive, from the network entity 105-b, a RAR message in an RAR window, where a beginning of the RAR window is based on a last symbol of a last preamble of the one or more preambles or a last uplink payload transmission of the one or more uplink payload transmissions associated with a first repetition level. For example, the network entity 105-b may transmit the RAR message based on when the UE 115-a transmits the preambles and PUSCH transmissions in accordance with the time-domain mapping pattern.

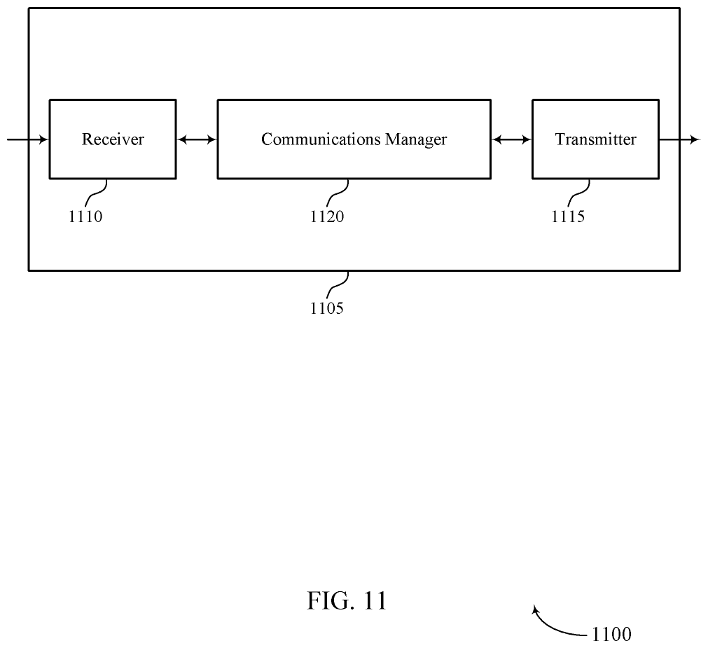

FIG. 11 shows a block diagram 1100 of a device 1105 that supports random access and uplink shared channel occasion mapping patterns for random access procedures in accordance with one or more aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to random access and uplink shared channel occasion mapping patterns for random access procedures). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to random access and uplink shared channel occasion mapping patterns for random access procedures). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of random access and uplink shared channel occasion mapping patterns for random access procedures as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a UE in accordance with examples as disclosed herein. For example, the communications manager 1120 may be configured as or otherwise support a means for receiving control signaling indicating a time-domain mapping pattern between one or more random access occasions and one or more uplink shared channel occasions for transmission of a random access message of a random access procedure. The communications manager 1120 may be configured as or otherwise support a means for transmitting, in the one or more random access occasions in accordance with the time-domain mapping pattern, one or more preambles of the random access message of the random access procedure. The communications manager 1120 may be configured as or otherwise support a means for transmitting, in the one or more uplink shared channel occasions in accordance with the time-domain mapping pattern, one or more uplink payload transmissions of the random access message of the random access procedure.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for including time-domain behaviors in RACH occasion-PUSCH occasion mapping patterns, which may increase signaling throughput, decrease latency, and improve signaling efficiency.

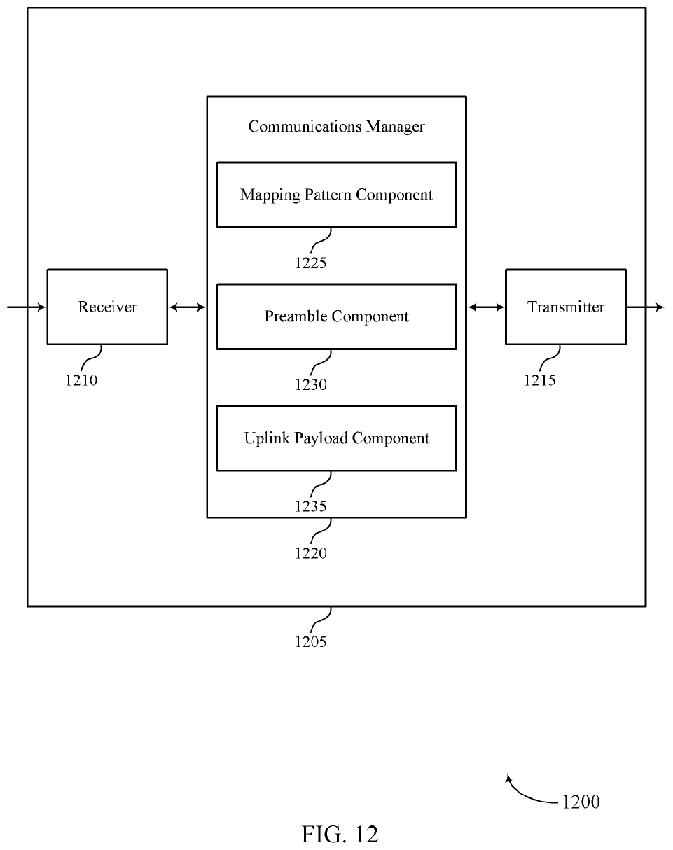

FIG. 12 shows a block diagram 1200 of a device 1205 that supports random access and uplink shared channel occasion mapping patterns for random access procedures in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to random access and uplink shared channel occasion mapping patterns for random access procedures). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to random access and uplink shared channel occasion mapping patterns for random access procedures). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of random access and uplink shared channel occasion mapping patterns for random access procedures as described herein. For example, the communications manager 1220 may include a mapping pattern component 1225, a preamble component 1230, an uplink payload component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a UE in accordance with examples as disclosed herein. The mapping pattern component 1225 may be configured as or otherwise support a means for receiving control signaling indicating a time-domain mapping pattern between one or more random access occasions and one or more uplink shared channel occasions for transmission of a random access message of a random access procedure. The preamble component 1230 may be configured as or otherwise support a means for transmitting, in the one or more random access occasions in accordance with the time-domain mapping pattern, one or more preambles of the random access message of the random access procedure. The uplink payload component 1235 may be configured as or otherwise support a means for transmitting, in the one or more uplink shared channel occasions in accordance with the time-domain mapping pattern, one or more uplink payload transmissions of the random access message of the random access procedure.

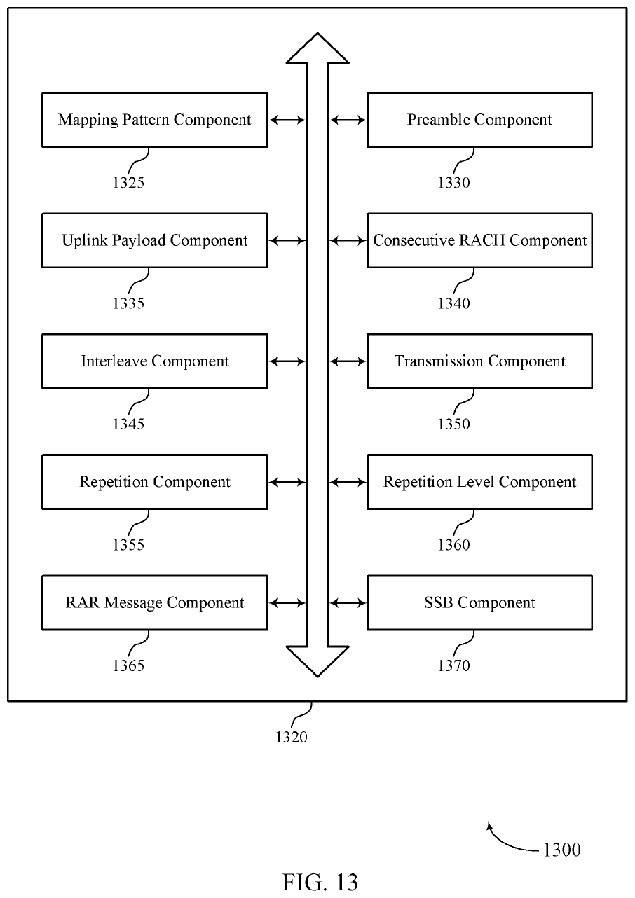

FIG. 13 shows a block diagram 1300 of a communications manager 1320 that supports random access and uplink shared channel occasion mapping patterns for random access procedures in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of random access and uplink shared channel occasion mapping patterns for random access procedures as described herein. For example, the communications manager 1320 may include a mapping pattern component 1325, a preamble component 1330, an uplink payload component 1335, a consecutive RACH component 1340, an interleave component 1345, a transmission component 1350, a repetition component 1355, a repetition level component 1360, a RAR message component 1365, an SSB component 1370, or any combination thereof. Each of these components may communicate, directly or indirectly, with one another (e.g., via one or more buses).

The communications manager 1320 may support wireless communication at a UE in accordance with examples as disclosed herein. The mapping pattern component 1325 may be configured as or otherwise support a means for receiving control signaling indicating a time-domain mapping pattern between one or more random access occasions and one or more uplink shared channel occasions for transmission of a random access message of a random access procedure. The preamble component 1330 may be configured as or otherwise support a means for transmitting, in the one or more random access occasions in accordance with the time-domain mapping pattern, one or more preambles of the random access message of the random access procedure. The uplink payload component 1335 may be configured as or otherwise support a means for transmitting, in the one or more uplink shared channel occasions in accordance with the time-domain mapping pattern, one or more uplink payload transmissions of the random access message of the random access procedure.

In some examples, the consecutive RACH component 1340 may be configured as or otherwise support a means for transmitting, in accordance with the time-domain mapping pattern, the one or more preambles in one or more consecutive random access occasions and the one or more uplink payload transmissions in one or more consecutive uplink shared channel occasions, where the one or more consecutive uplink shared channel occasions are subsequent to the one or more consecutive random access occasions.

In some examples, the interleave component 1345 may be configured as or otherwise support a means for receiving the control signaling indicating the time-domain mapping pattern, where the time-domain mapping pattern indicates that the one or more random access occasions and the one or more uplink shared channel occasions are interleaved in a time domain. In some examples, the transmission component 1350 may be configured as or otherwise support a means for transmitting the one or more preambles and the one or more uplink payload transmissions, where the one or more preambles and the one or more uplink payload transmissions are interleaved based on the time-domain mapping pattern.

In some examples, to support transmitting the one or more preambles, the preamble component 1330 may be configured as or otherwise support a means for transmitting, in accordance with the time-domain mapping pattern, the one or more preambles in one or more consecutive random access occasions that are TDMed within one or more random access slots.

In some examples, to support transmitting the one or more uplink payload transmissions, the preamble component 1330 may be configured as or otherwise support a means for transmitting, in accordance with the time-domain mapping pattern, the one or more uplink payload transmissions in one or more consecutive uplink shared channel occasions that are TDMed, where the one or more uplink payload transmissions are associated with a subset of the one or more preambles.

In some examples, the repetition component 1355 may be configured as or otherwise support a means for transmitting, in accordance with the time-domain mapping pattern, the one or more preambles in the one or more random access occasions and a first uplink payload transmission of the one or more uplink payload transmissions in a first uplink shared channel occasion of the one or more uplink shared channel occasions.

In some examples, the repetition component 1355 may be configured as or otherwise support a means for transmitting, in accordance with the time-domain mapping pattern, a first preamble of the one or more preambles in a first random access occasion of the one or more random access occasions and the one or more uplink payload transmissions in the one or more uplink shared channel occasions.

In some examples, the repetition level component 1360 may be configured as or otherwise support a means for receiving the control signaling indicating the time-domain mapping pattern between the one or more random access occasions and the one or more uplink shared channel occasions, the time-domain mapping pattern based on a set of joint preamble and uplink payload transmission repetitions associated with one or more repetition levels, where the set of joint preamble and uplink payload transmission repetitions is TDMed, FDMed, or CDMed.

In some examples, for the set of joint preamble and uplink payload transmission repetitions that is CDMed, a first joint payload and uplink payload transmission repetition is associated with one or more repetition levels.

In some examples, the RAR message component 1365 may be configured as or otherwise support a means for receiving a RAR message in a RAR window, where a beginning of the RAR window is based on a last symbol of a last preamble of the one or more preambles or a last uplink payload transmission of the one or more uplink payload transmissions associated with a first repetition level.

In some examples, the SSB component 1370 may be configured as or otherwise support a means for transmitting a set of joint preamble and uplink payload transmission repetitions, where the set of joint preamble and uplink payload transmission repetitions is associated with one or more SSBs for a given repetition level.

In some examples, the SSB component 1370 may be configured as or otherwise support a means for selecting a first joint preamble and uplink payload transmission repetition of the set of joint preamble and uplink payload transmission repetitions based on an SSB associated with the first joint preamble and uplink payload transmission repetition corresponding to a highest identified RSRP. In some examples, a quantity of SSBs associated with a highest identified RSRP is associated with a repetition level.

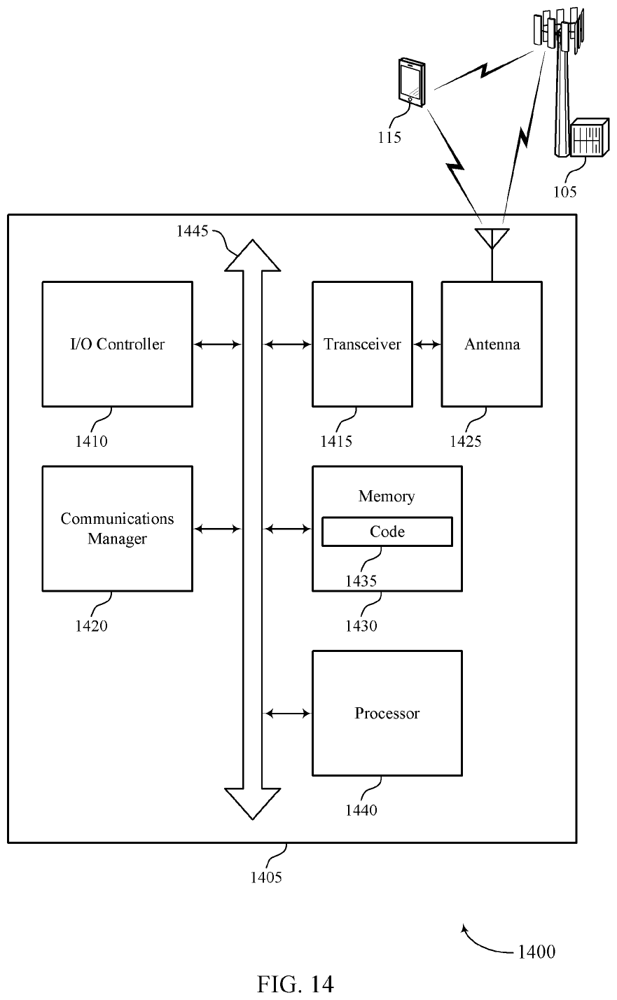

FIG. 14 shows a diagram of a system 1400 including a device 1405 that supports random access and uplink shared channel occasion mapping patterns for random access procedures in accordance with one or more aspects of the present disclosure. The device 1405 may be an example of or include the components of a device 1105, a device 1205, or a UE 115 as described herein. The device 1405 may communicate (e.g., wirelessly) with one or more network entities 105, one or more UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting random access and uplink shared channel occasion mapping patterns for random access procedures). For example, the device 1405 or a component of the device 1405 may include a processor 1440 and memory 1430 coupled with or to the processor 1440, the processor 1440 and memory 1430 configured to perform various functions described herein.

The communications manager 1420 may support wireless communication at a UE in accordance with examples as disclosed herein. For example, the communications manager 1420 may be configured as or otherwise support a means for receiving control signaling indicating a time-domain mapping pattern between one or more random access occasions and one or more uplink shared channel occasions for transmission of a random access message of a random access procedure. The communications manager 1420 may be configured as or otherwise support a means for transmitting, in the one or more random access occasions in accordance with the time-domain mapping pattern, one or more preambles of the random access message of the random access procedure. The communications manager 1420 may be configured as or otherwise support a means for transmitting, in the one or more uplink shared channel occasions in accordance with the time-domain mapping pattern, one or more uplink payload transmissions of the random access message of the random access procedure.

By including or configuring the communications manager 1420 in accordance with examples as described herein, the device 1405 may support techniques for including time-domain behaviors in RACH occasion-PUSCH occasion mapping patterns, which may increase signaling throughput, decrease latency, and improve signaling efficiency.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of random access and uplink shared channel occasion mapping patterns for random access procedures as described herein, or the processor 1440 and the memory 1430 may be otherwise configured to perform or support such operations.

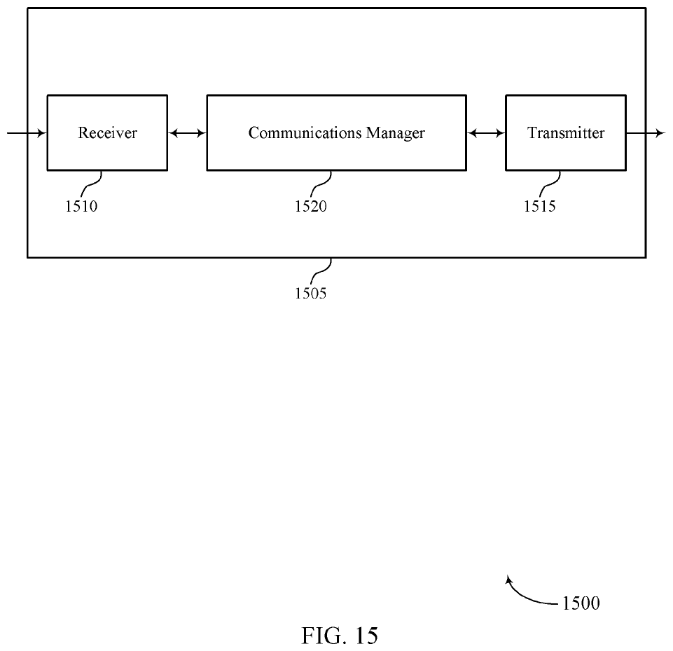

FIG. 15 shows a block diagram 1500 of a device 1505 that supports random access and uplink shared channel occasion mapping patterns for random access procedures in accordance with one or more aspects of the present disclosure. The device 1505 may be an example of aspects of a network entity 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The communications manager 1520, the receiver 1510, the transmitter 1515, or various combinations thereof or various components thereof may be examples of means for performing various aspects of random access and uplink shared channel occasion mapping patterns for random access procedures as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1520, the receiver 1510, the transmitter 1515, or various combinations or components thereof may be implemented in code (e.g., as communications management software or firmware) executed by a processor. If implemented in code executed by a processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communication at a network entity in accordance with examples as disclosed herein. For example, the communications manager 1520 may be configured as or otherwise support a means for transmitting control signaling indicating a time-domain mapping pattern between one or more random access occasions and one or more uplink shared channel occasions for transmission of a random access message of a random access procedure. The communications manager 1520 may be configured as or otherwise support a means for receiving, in the one or more random access occasions in accordance with the time-domain mapping pattern, one or more preambles of the random access message of the random access procedure. The communications manager 1520 may be configured as or otherwise support a means for receiving, in the one or more uplink shared channel occasions in accordance with the time-domain mapping pattern, one or more uplink payload transmissions of the random access message of the random access procedure.

By including or configuring the communications manager 1520 in accordance with examples as described herein, the device 1505 (e.g., a processor controlling or otherwise coupled with the receiver 1510, the transmitter 1515, the communications manager 1520, or a combination thereof) may support techniques for including time-domain behaviors in RACH occasion-PUSCH occasion mapping patterns, which may increase signaling throughput, decrease latency, and improve signaling efficiency.

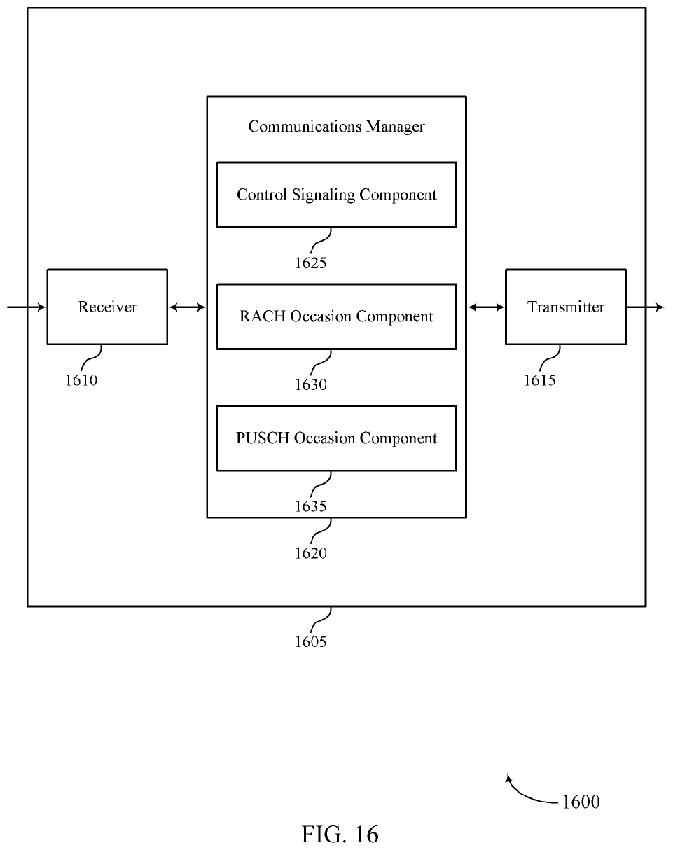

FIG. 16 shows a block diagram 1600 of a device 1605 that supports random access and uplink shared channel occasion mapping patterns for random access procedures in accordance with one or more aspects of the present disclosure. The device 1605 may be an example of aspects of a device 1505 or a network entity 105 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The device 1605, or various components thereof, may be an example of means for performing various aspects of random access and uplink shared channel occasion mapping patterns for random access procedures as described herein. For example, the communications manager 1620 may include a control signaling component 1625, a RACH occasion component 1630, an PUSCH occasion component 1635, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communication at a network entity in accordance with examples as disclosed herein. The control signaling component 1625 may be configured as or otherwise support a means for transmitting control signaling indicating a time-domain mapping pattern between one or more random access occasions and one or more uplink shared channel occasions for transmission of a random access message of a random access procedure. The RACH occasion component 1630 may be configured as or otherwise support a means for receiving, in the one or more random access occasions in accordance with the time-domain mapping pattern, one or more preambles of the random access message of the random access procedure. The PUSCH occasion component 1635 may be configured as or otherwise support a means for receiving, in the one or more uplink shared channel occasions in accordance with the time-domain mapping pattern, one or more uplink payload transmissions of the random access message of the random access procedure.

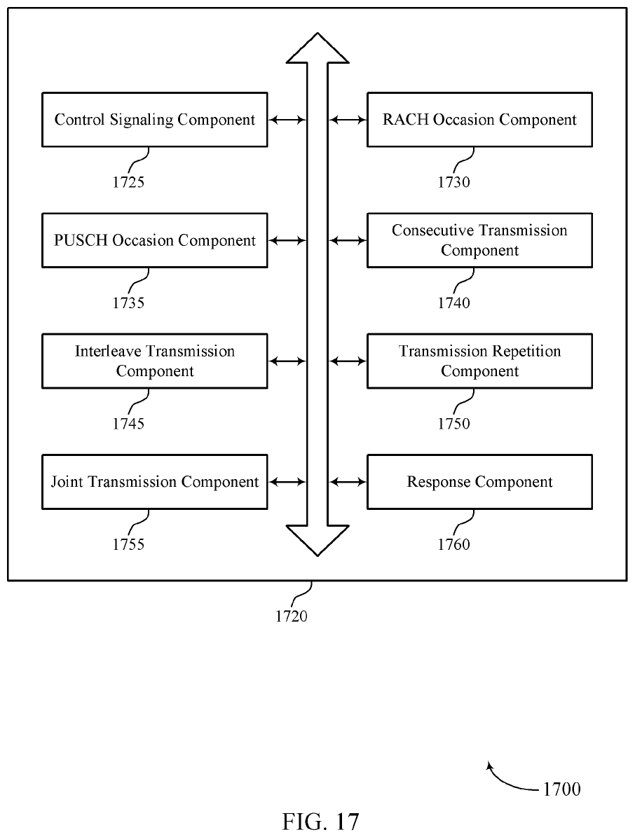

FIG. 17 shows a block diagram 1700 of a communications manager 1720 that supports random access and uplink shared channel occasion mapping patterns for random access procedures in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of random access and uplink shared channel occasion mapping patterns for random access procedures as described herein. For example, the communications manager 1720 may include a control signaling component 1725, a RACH occasion component 1730, an PUSCH occasion component 1735, a consecutive transmission component 1740, an interleave transmission component 1745, a transmission repetition component 1750, a joint transmission component 1755, a response component 1760, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1720 may support wireless communication at a network entity in accordance with examples as disclosed herein. The control signaling component 1725 may be configured as or otherwise support a means for transmitting control signaling indicating a time-domain mapping pattern between one or more random access occasions and one or more uplink shared channel occasions for transmission of a random access message of a random access procedure. The RACH occasion component 1730 may be configured as or otherwise support a means for receiving, in the one or more random access occasions in accordance with the time-domain mapping pattern, one or more preambles of the random access message of the random access procedure. The PUSCH occasion component 1735 may be configured as or otherwise support a means for receiving, in the one or more uplink shared channel occasions in accordance with the time-domain mapping pattern, one or more uplink payload transmissions of the random access message of the random access procedure.

In some examples, the consecutive transmission component 1740 may be configured as or otherwise support a means for receiving, in accordance with the time-domain mapping pattern, the one or more preambles in one or more consecutive random access occasions and the one or more uplink payload transmissions in one or more consecutive uplink shared channel occasions, where the one or more consecutive uplink shared channel occasions are subsequent to the one or more consecutive random access occasions.

In some examples, the interleave transmission component 1745 may be configured as or otherwise support a means for transmitting the control signaling indicating the time-domain mapping pattern, where the time-domain mapping pattern indicates that the one or more random access occasions and the one or more uplink shared channel occasions are interleaved in a time domain. In some examples, the interleave transmission component 1745 may be configured as or otherwise support a means for receiving the one or more preambles and the one or more uplink payload transmissions, where the one or more preambles and the one or more uplink payload transmissions are interleaved based on the time-domain mapping pattern.

In some examples, to support receiving the one or more preambles, the RACH occasion component 1730 may be configured as or otherwise support a means for receiving, in accordance with the time-domain mapping pattern, the one or more preambles in one or more consecutive random access occasions that are TDMed within one or more random access slots.

In some examples, to support receiving the one or more uplink payload transmissions, the PUSCH occasion component 1735 may be configured as or otherwise support a means for receiving, in accordance with the time-domain mapping pattern, the one or more uplink payload transmissions in one or more consecutive uplink shared channel occasions that are TDMed, where the one or more uplink payload transmissions are associated with a subset of the one or more preambles.

In some examples, the transmission repetition component 1750 may be configured as or otherwise support a means for receiving, in accordance with the time-domain mapping pattern, the one or more preambles in the one or more random access occasions and a first uplink payload transmission of the one or more uplink payload transmissions in a first uplink shared channel occasion of the one or more uplink shared channel occasions.

In some examples, the transmission repetition component 1750 may be configured as or otherwise support a means for receiving, in accordance with the time-domain mapping pattern, a first preamble of the one or more preambles in a first random access occasion of the one or more random access occasions and the one or more uplink payload transmissions in the one or more uplink shared channel occasions.

In some examples, the joint transmission component 1755 may be configured as or otherwise support a means for transmitting the control signaling indicating the time-domain mapping pattern between the one or more random access occasions and the one or more uplink shared channel occasions, the time-domain mapping pattern based on a set of joint preamble and uplink payload transmission repetitions associated with one or more repetition levels, where the set of joint preamble and uplink payload transmission repetitions is TDMed, FDMed, or CDMed.

In some examples, for the set of joint preamble and uplink payload transmission repetitions that is CDMed, a first joint payload and uplink payload transmission repetition is associated with one or more repetition levels.

In some examples, the response component 1760 may be configured as or otherwise support a means for transmitting a RAR message in a RAR window, where a beginning of the RAR window is based on a last symbol of a last preamble of the one or more preambles or a last uplink payload transmission of the one or more uplink payload transmissions associated with a first repetition level.

In some examples, the joint transmission component 1755 may be configured as or otherwise support a means for receiving a set of joint preamble and uplink payload transmission repetitions, where the set of joint preamble and uplink payload transmission repetitions is associated with one or more SSBs for a given repetition level. In some examples, a quantity of SSBs associated with a highest identified RSRP is associated with a repetition level.

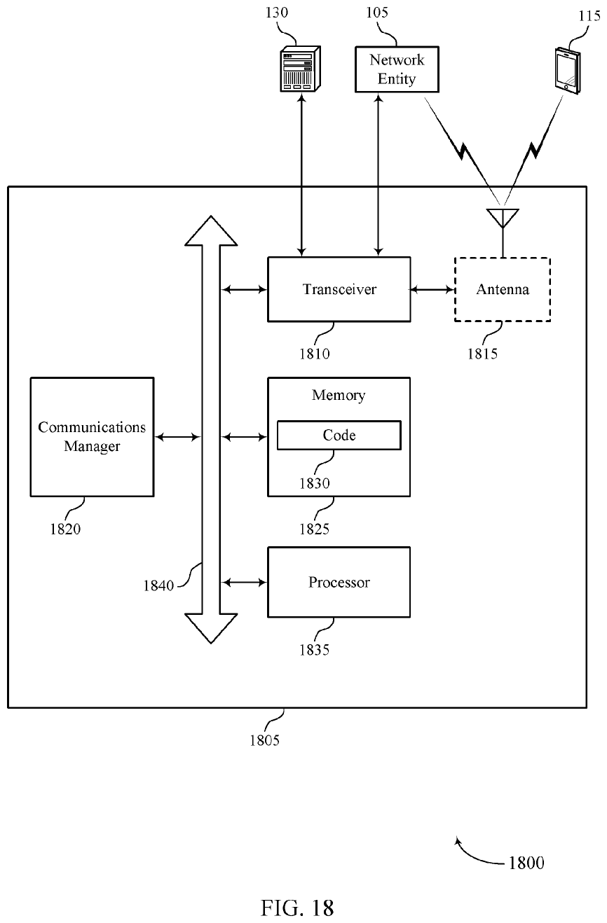

FIG. 18 shows a diagram of a system 1800 including a device 1805 that supports random access and uplink shared channel occasion mapping patterns for random access procedures in accordance with one or more aspects of the present disclosure. The device 1805 may be an example of or include the components of a device 1505, a device 1605, or a network entity 105 as described herein. The device 1805 may communicate with one or more network entities 105, one or more UEs 115, or any combination thereof, which may include communications over one or more wired interfaces, over one or more wireless interfaces, or any combination thereof. The device 1805 may include components that support outputting and obtaining communications, such as a communications manager 1820, a transceiver 1810, an antenna 1815, a memory 1825, code 1830, and a processor 1835. These components may be in electronic communication or otherwise coupled (e.g., operatively, communicatively, functionally, electronically, electrically) via one or more buses (e.g., a bus 1840).

The transceiver 1810 may support bi-directional communications via wired links, wireless links, or both as described herein. In some examples, the transceiver 1810 may include a wired transceiver and may communicate bi-directionally with another wired transceiver. Additionally, or alternatively, in some examples, the transceiver 1810 may include a wireless transceiver and may communicate bi-directionally with another wireless transceiver. In some examples, the device 1805 may include one or more antennas 1815, which may be capable of transmitting or receiving wireless transmissions (e.g., concurrently). The transceiver 1810 may also include a modem to modulate signals, to provide the modulated signals for transmission (e.g., by one or more antennas 1815, by a wired transmitter), to receive modulated signals (e.g., from one or more antennas 1815, from a wired receiver), and to demodulate signals. In some implementations, the transceiver 1810 may include one or more interfaces, such as one or more interfaces coupled with the one or more antennas 1815 that are configured to support various receiving or obtaining operations, or one or more interfaces coupled with the one or more antennas 1815 that are configured to support various transmitting or outputting operations, or a combination thereof. In some implementations, the transceiver 1810 may include or be configured for coupling with one or more processors or memory components that are operable to perform or support operations based on received or obtained information or signals, or to generate information or other signals for transmission or other outputting, or any combination thereof. In some implementations, the transceiver 1810, or the transceiver 1810 and the one or more antennas 1815, or the transceiver 1810 and the one or more antennas 1815 and one or more processors or memory components (for example, the processor 1835, or the memory 1825, or both), may be included in a chip or chip assembly that is installed in the device 1805. In some examples, the transceiver may be operable to support communications via one or more communications links (e.g., a communication link 125, a backhaul communication link 120, a midhaul communication link 162, a fronthaul communication link 168).

The memory 1825 may include RAM and ROM. The memory 1825 may store computer-readable, computer-executable code 1830 including instructions that, when executed by the processor 1835, cause the device 1805 to perform various functions described herein. The code 1830 may be stored in a non-transitory computer-readable medium such as system memory or another type of memory. In some cases, the code 1830 may not be directly executable by the processor 1835 but may cause a computer (e.g., when compiled and executed) to perform functions described herein. In some cases, the memory 1825 may contain, among other things, a BIOS which may control basic hardware or software operation such as the interaction with peripheral components or devices.

The processor 1835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1835 may be configured to operate a memory array using a memory controller. In some other cases, a memory controller may be integrated into the processor 1835. The processor 1835 may be configured to execute computer-readable instructions stored in a memory (e.g., the memory 1825) to cause the device 1805 to perform various functions (e.g., functions or tasks supporting random access and uplink shared channel occasion mapping patterns for random access procedures). For example, the device 1805 or a component of the device 1805 may include a processor 1835 and memory 1825 coupled with the processor 1835, the processor 1835 and memory 1825 configured to perform various functions described herein. The processor 1835 may be an example of a cloud-computing platform (e.g., one or more physical nodes and supporting software such as operating systems, virtual machines, or container instances) that may host the functions (e.g., by executing code 1830) to perform the functions of the device 1805. The processor 1835 may be any one or more suitable processors capable of executing scripts or instructions of one or more software programs stored in the device 1805 (such as within the memory 1825). In some implementations, the processor 1835 may be a component of a processing system. A processing system may generally refer to a system or series of machines or components that receives inputs and processes the inputs to produce a set of outputs (which may be passed to other systems or components of, for example, the device 1805). For example, a processing system of the device 1805 may refer to a system including the various other components or subcomponents of the device 1805, such as the processor 1835, or the transceiver 1810, or the communications manager 1820, or other components or combinations of components of the device 1805. The processing system of the device 1805 may interface with other components of the device 1805, and may process information received from other components (such as inputs or signals) or output information to other components. For example, a chip or modem of the device 1805 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1805 may transmit information output from the chip or modem. Additionally, or alternatively, in some implementations, the one or more interfaces may refer to an interface between the processing system of the chip or modem and a receiver, such that the device 1805 may obtain information or signal inputs, and the information may be passed to the processing system. A person having ordinary skill in the art will readily recognize that a first interface also may obtain information or signal inputs, and a second interface also may output information or signal outputs.

In some examples, a bus 1840 may support communications of (e.g., within) a protocol layer of a protocol stack. In some examples, a bus 1840 may support communications associated with a logical channel of a protocol stack (e.g., between protocol layers of a protocol stack), which may include communications performed within a component of the device 1805, or between different components of the device 1805 that may be co-located or located in different locations (e.g., where the device 1805 may refer to a system in which one or more of the communications manager 1820, the transceiver 1810, the memory 1825, the code 1830, and the processor 1835 may be located in one of the different components or divided between different components).

In some examples, the communications manager 1820 may manage aspects of communications with a core network 130 (e.g., via one or more wired or wireless backhaul links). For example, the communications manager 1820 may manage the transfer of data communications for client devices, such as one or more UEs 115. In some examples, the communications manager 1820 may manage communications with other network entities 105, and may include a controller or scheduler for controlling communications with UEs 115 in cooperation with other network entities 105. In some examples, the communications manager 1820 may support an X2 interface within an LTE/LTE-A wireless communications network technology to provide communication between network entities 105.

The communications manager 1820 may support wireless communication at a network entity in accordance with examples as disclosed herein. For example, the communications manager 1820 may be configured as or otherwise support a means for transmitting control signaling indicating a time-domain mapping pattern between one or more random access occasions and one or more uplink shared channel occasions for transmission of a random access message of a random access procedure. The communications manager 1820 may be configured as or otherwise support a means for receiving, in the one or more random access occasions in accordance with the time-domain mapping pattern, one or more preambles of the random access message of the random access procedure. The communications manager 1820 may be configured as or otherwise support a means for receiving, in the one or more uplink shared channel occasions in accordance with the time-domain mapping pattern, one or more uplink payload transmissions of the random access message of the random access procedure.

By including or configuring the communications manager 1820 in accordance with examples as described herein, the device 1805 may support techniques for including time-domain behaviors in RACH occasion-PUSCH occasion mapping patterns, which may increase signaling throughput, decrease latency, and improve signaling efficiency.

In some examples, the communications manager 1820 may be configured to perform various operations (e.g., receiving, obtaining, monitoring, outputting, transmitting) using or otherwise in cooperation with the transceiver 1810, the one or more antennas 1815 (e.g., where applicable), or any combination thereof. Although the communications manager 1820 is illustrated as a separate component, in some examples, one or more functions described with reference to the communications manager 1820 may be supported by or performed by the transceiver 1810, the processor 1835, the memory 1825, the code 1830, or any combination thereof. For example, the code 1830 may include instructions executable by the processor 1835 to cause the device 1805 to perform various aspects of random access and uplink shared channel occasion mapping patterns for random access procedures as described herein, or the processor 1835 and the memory 1825 may be otherwise configured to perform or support such operations.

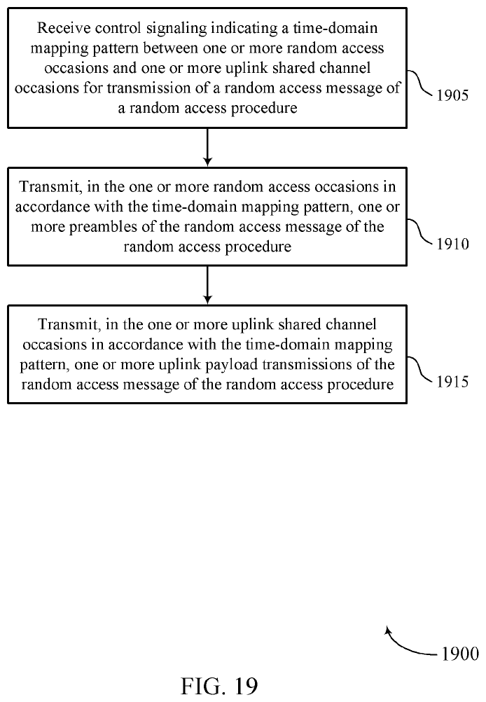

FIG. 19 shows a flowchart illustrating a method 1900 that supports random access and uplink shared channel occasion mapping patterns for random access procedures in accordance with one or more aspects of the present disclosure. The operations of the method 1900 may be implemented by a UE or its components as described herein. For example, the operations of the method 1900 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1905, the method may include receiving control signaling indicating a time-domain mapping pattern between one or more random access occasions and one or more uplink shared channel occasions for transmission of a random access message of a random access procedure. The operations of 1905 may be performed in accordance with examples as disclosed herein. In some examples, aspects of the operations of 1905 may be performed by a mapping pattern component 1325 as described with reference to FIG. 13.

At 1910, the method may include transmitting, in the one or more random access occasions in accordance with the time-domain mapping pattern, one or more preambles of the random access message of the random access procedure. The operations of 1910 may be performed in accordance with examples as disclosed herein. In some examples, aspects of the operations of 1910 may be performed by a preamble component 1330 as described with reference to FIG. 13.

At 1915, the method may include transmitting, in the one or more uplink shared channel occasions in accordance with the time-domain mapping pattern, one or more uplink payload transmissions of the random access message of the random access procedure. The operations of 1915 may be performed in accordance with examples as disclosed herein. In some examples, aspects of the operations of 1915 may be performed by an uplink payload component 1335 as described with reference to FIG. 13.

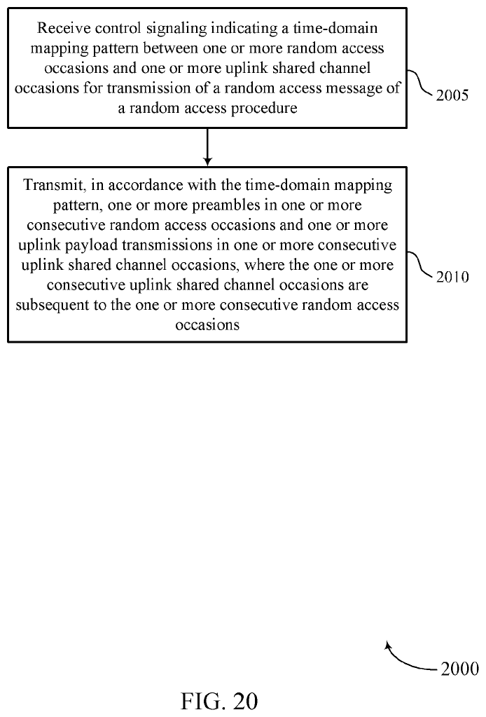

FIG. 20 shows a flowchart illustrating a method 2000 that supports random access and uplink shared channel occasion mapping patterns for random access procedures in accordance with one or more aspects of the present disclosure. The operations of the method 2000 may be implemented by a UE or its components as described herein. For example, the operations of the method 2000 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 2005, the method may include receiving control signaling indicating a time-domain mapping pattern between one or more random access occasions and one or more uplink shared channel occasions for transmission of a random access message of a random access procedure. The operations of 2005 may be performed in accordance with examples as disclosed herein. In some examples, aspects of the operations of 2005 may be performed by a mapping pattern component 1325 as described with reference to FIG. 13.

At 2010, the method may include transmitting, in accordance with the time-domain mapping pattern, one or more preambles in one or more consecutive random access occasions and one or more uplink payload transmissions in one or more consecutive uplink shared channel occasions, where the one or more consecutive uplink shared channel occasions are subsequent to the one or more consecutive random access occasions. The operations of 2010 may be performed in accordance with examples as disclosed herein. In some examples, aspects of the operations of 2010 may be performed by a consecutive RACH component 1340 as described with reference to FIG. 13.

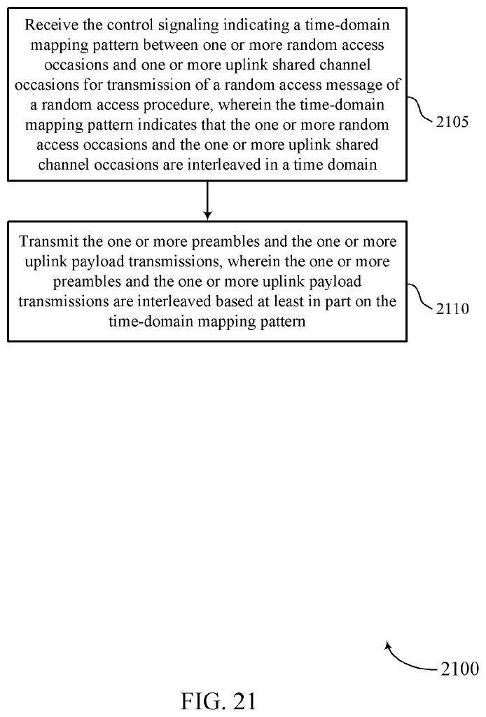

FIG. 21 shows a flowchart illustrating a method 2100 that supports random access and uplink shared channel occasion mapping patterns for random access procedures in accordance with one or more aspects of the present disclosure. The operations of the method 2100 may be implemented by a UE or its components as described herein. For example, the operations of the method 2100 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 2105, the method may include receiving the control signaling indicating a time-domain mapping pattern between one or more random access occasions and one or more uplink shared channel occasions for transmission of a random access message of a random access procedure, where the time-domain mapping pattern indicates that the one or more random access occasions and the one or more uplink shared channel occasions are interleaved in a time domain. The operations of 2105 may be performed in accordance with examples as disclosed herein. In some examples, aspects of the operations of 2105 may be performed by an interleave component 1345 as described with reference to FIG. 13.

At 2110, the method may include transmitting the one or more preambles and the one or more uplink payload transmissions, where the one or more preambles and the one or more uplink payload transmissions are interleaved based on the time-domain mapping pattern. The operations of 2110 may be performed in accordance with examples as disclosed herein. In some examples, aspects of the operations of 2110 may be performed by a transmission component 1350 as described with reference to FIG. 13.

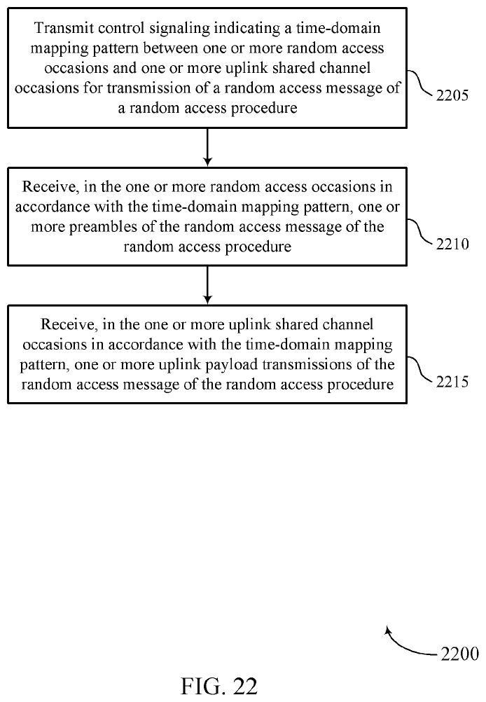

FIG. 22 shows a flowchart illustrating a method 2200 that supports random access and uplink shared channel occasion mapping patterns for random access procedures in accordance with one or more aspects of the present disclosure. The operations of the method 2200 may be implemented by a network entity or its components as described herein. For example, the operations of the method 2200 may be performed by a network entity as described with reference to FIGS. 1 through 10 and 15 through 18. In some examples, a network entity may execute a set of instructions to control the functional elements of the network entity to perform the described functions. Additionally, or alternatively, the network entity may perform aspects of the described functions using special-purpose hardware.

At 2205, the method may include transmitting control signaling indicating a time-domain mapping pattern between one or more random access occasions and one or more uplink shared channel occasions for transmission of a random access message of a random access procedure. The operations of 2205 may be performed in accordance with examples as disclosed herein. In some examples, aspects of the operations of 2205 may be performed by a control signaling component 1725 as described with reference to FIG. 17.

At 2210, the method may include receiving, in the one or more random access occasions in accordance with the time-domain mapping pattern, one or more preambles of the random access message of the random access procedure. The operations of 2210 may be performed in accordance with examples as disclosed herein. In some examples, aspects of the operations of 2210 may be performed by a RACH occasion component 1730 as described with reference to FIG. 17.

At 2215, the method may include receiving, in the one or more uplink shared channel occasions in accordance with the time-domain mapping pattern, one or more uplink payload transmissions of the random access message of the random access procedure. The operations of 2215 may be performed in accordance with examples as disclosed herein. In some examples, aspects of the operations of 2215 may be performed by an PUSCH occasion component 1735 as described with reference to FIG. 17.

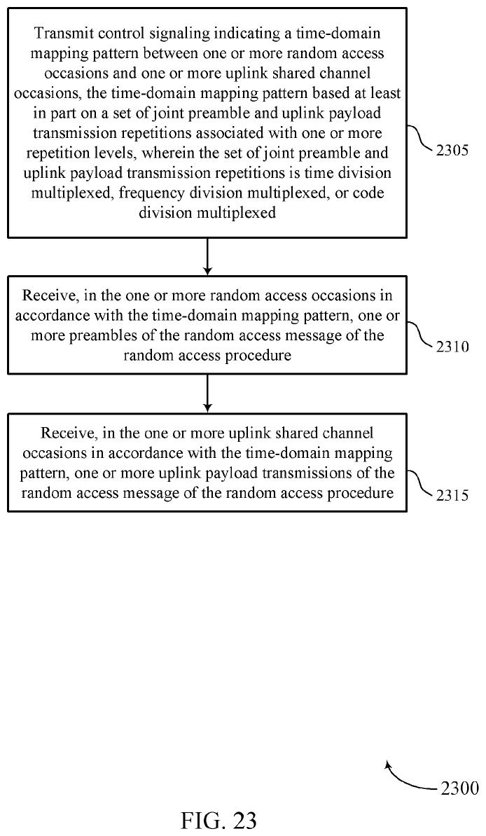

FIG. 23 shows a flowchart illustrating a method 2300 that supports random access and uplink shared channel occasion mapping patterns for random access procedures in accordance with one or more aspects of the present disclosure. The operations of the method 2300 may be implemented by a network entity or its components as described herein. For example, the operations of the method 2300 may be performed by a network entity as described with reference to FIGS. 1 through 10 and 15 through 18. In some examples, a network entity may execute a set of instructions to control the functional elements of the network entity to perform the described functions. Additionally, or alternatively, the network entity may perform aspects of the described functions using special-purpose hardware.

At 2305, the method may include transmitting control signaling indicating a time-domain mapping pattern between one or more random access occasions and one or more uplink shared channel occasions, the time-domain mapping pattern based on a set of joint preamble and uplink payload transmission repetitions associated with one or more repetition levels, where the set of joint preamble and uplink payload transmission repetitions is TDMed, FDMed, or CDMed. The operations of 2305 may be performed in accordance with examples as disclosed herein. In some examples, aspects of the operations of 2305 may be performed by a joint transmission component 1755 as described with reference to FIG. 17.

At 2310, the method may include transmitting control signaling indicating a time-domain mapping pattern between one or more random access occasions and one or more uplink shared channel occasions for transmission of a random access message of a random access procedure. The operations of 2310 may be performed in accordance with examples as disclosed herein. In some examples, aspects of the operations of 2310 may be performed by a control signaling component 1725 as described with reference to FIG. 17.

At 2315, the method may include receiving, in the one or more random access occasions in accordance with the time-domain mapping pattern, one or more preambles of the random access message of the random access procedure. The operations of 2315 may be performed in accordance with examples as disclosed herein. In some examples, aspects of the operations of 2315 may be performed by a RACH occasion component 1730 as described with reference to FIG. 17.

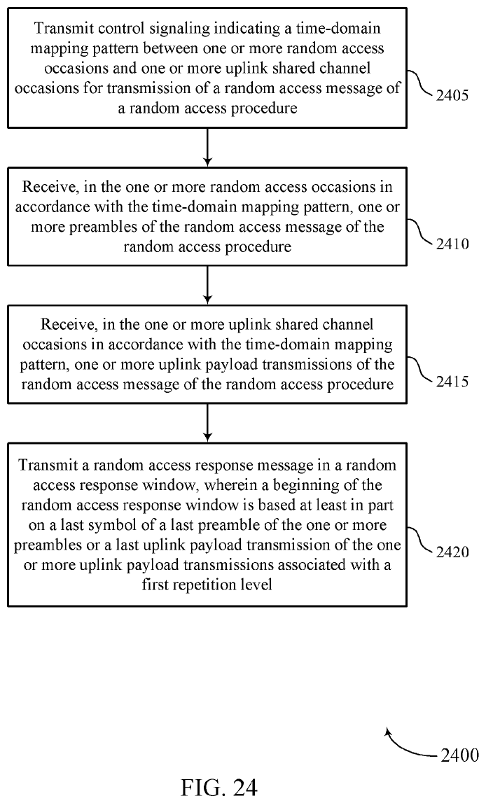

FIG. 24 shows a flowchart illustrating a method 2400 that supports random access and uplink shared channel occasion mapping patterns for random access procedures in accordance with one or more aspects of the present disclosure. The operations of the method 2400 may be implemented by a network entity or its components as described herein. For example, the operations of the method 2400 may be performed by a network entity as described with reference to FIGS. 1 through 10 and 15 through 18. In some examples, a network entity may execute a set of instructions to control the functional elements of the network entity to perform the described functions. Additionally, or alternatively, the network entity may perform aspects of the described functions using special-purpose hardware.

At 2405, the method may include transmitting control signaling indicating a time-domain mapping pattern between one or more random access occasions and one or more uplink shared channel occasions for transmission of a random access message of a random access procedure. The operations of 2405 may be performed in accordance with examples as disclosed herein. In some examples, aspects of the operations of 2405 may be performed by a control signaling component 1725 as described with reference to FIG. 17.

At 2410, the method may include receiving, in the one or more random access occasions in accordance with the time-domain mapping pattern, one or more preambles of the random access message of the random access procedure. The operations of 2410 may be performed in accordance with examples as disclosed herein. In some examples, aspects of the operations of 2410 may be performed by a RACH occasion component 1730 as described with reference to FIG. 17.

At 2415, the method may include receiving, in the one or more uplink shared channel occasions in accordance with the time-domain mapping pattern, one or more uplink payload transmissions of the random access message of the random access procedure. The operations of 2415 may be performed in accordance with examples as disclosed herein. In some examples, aspects of the operations of 2415 may be performed by an PUSCH occasion component 1735 as described with reference to FIG. 17.

At 2420, the method may include transmitting a RAR message in a RAR window, where a beginning of the RAR window is based on a last symbol of a last preamble of the one or more preambles or a last uplink payload transmission of the one or more uplink payload transmissions associated with a first repetition level. The operations of 2420 may be performed in accordance with examples as disclosed herein. In some examples, aspects of the operations of 2420 may be performed by a response component 1760 as described with reference to FIG. 17.

The following provides an overview of aspects of the present disclosure:
Aspect 1: A method for wireless communication at a UE, comprising: receiving control signaling indicating a time-domain mapping pattern between one or more random access occasions and one or more uplink shared channel occasions for transmission of a random access message of a random access procedure; transmitting, in the one or more random access occasions in accordance with the time-domain mapping pattern, one or more preambles of the random access message of the random access procedure; and transmitting, in the one or more uplink shared channel occasions in accordance with the time-domain mapping pattern, one or more uplink payload transmissions of the random access message of the random access procedure.
Aspect 2: The method of aspect 1, further comprising: transmitting, in accordance with the time-domain mapping pattern, the one or more preambles in one or more consecutive random access occasions and the one or more uplink payload transmissions in one or more consecutive uplink shared channel occasions, where the one or more consecutive uplink shared channel occasions are subsequent to the one or more consecutive random access occasions.
Aspect 3: The method of any of aspects 1 through 2, further comprising: receiving the control signaling indicating the time-domain mapping pattern, wherein the time-domain mapping pattern indicates that the one or more random access occasions and the one or more uplink shared channel occasions are interleaved in a time domain; and transmitting the one or more preambles and the one or more uplink payload transmissions, wherein the one or more preambles and the one or more uplink payload transmissions are interleaved based at least in part on the time-domain mapping pattern.
Aspect 4: The method of any of aspects 1 through 3, wherein transmitting the one or more preambles comprises: transmitting, in accordance with the time-domain mapping pattern, the one or more preambles in one or more consecutive random access occasions that are TDMed within one or more random access slots.
Aspect 5: The method of any of aspects 1 through 4, wherein transmitting the one or more uplink payload transmissions comprises: transmitting, in accordance with the time-domain mapping pattern, the one or more uplink payload transmissions in one or more consecutive uplink shared channel occasions that are TDMed, wherein the one or more uplink payload transmissions are associated with a subset of the one or more preambles.
Aspect 6: The method of any of aspects 1 through 5, further comprising: transmitting, in accordance with the time-domain mapping pattern, the one or more preambles in the one or more random access occasions and a first uplink payload transmission of the one or more uplink payload transmissions in a first uplink shared channel occasion of the one or more uplink shared channel occasions.
Aspect 7: The method of any of aspects 1 through 6, further comprising: transmitting, in accordance with the time-domain mapping pattern, a first preamble of the one or more preambles in a first random access occasion of the one or more random access occasions and the one or more uplink payload transmissions in the one or more uplink shared channel occasions.
Aspect 8: The method of any of aspects 1 through 7, further comprising: receiving the control signaling indicating the time-domain mapping pattern between the one or more random access occasions and the one or more uplink shared channel occasions, the time-domain mapping pattern based at least in part on a set of joint preamble and uplink payload transmission repetitions associated with one or more repetition levels, wherein the set of joint preamble and uplink payload transmission repetitions is TDMed, FDMed, or CDMed.
Aspect 9: The method of aspect 8, wherein, for the set of joint preamble and uplink payload transmission repetitions that is CDMed, a first joint payload and uplink payload transmission repetition is associated with one or more repetition levels.
Aspect 10: The method of any of aspects 1 through 9, further comprising: receiving an RAR message in an RAR window, wherein a beginning of the RAR window is based at least in part on a last symbol of a last preamble of the one or more preambles or a last uplink payload transmission of the one or more uplink payload transmissions associated with a first repetition level.
Aspect 11: The method of any of aspects 1 through 10, further comprising: transmitting a set of joint preamble and uplink payload transmission repetitions, wherein the set of joint preamble and uplink payload transmission repetitions is associated with one or more SSBs for a given repetition level.
Aspect 12: The method of aspect 11, further comprising: selecting a first joint preamble and uplink payload transmission repetition of the set of joint preamble and uplink payload transmission repetitions based at least in part on an SSB associated with the first joint preamble and uplink payload transmission repetition corresponding to a highest identified RSRP.
Aspect 13: The method of any of aspects 11 through 12, wherein a quantity of SSBs associated with a highest identified RSRP is associated with a repetition level.
Aspect 14: A method for wireless communication at a network entity, comprising: transmitting control signaling indicating a time-domain mapping pattern between one or more random access occasions and one or more uplink shared channel occasions for transmission of a random access message of a random access procedure; receiving, in the one or more random access occasions in accordance with the time-domain mapping pattern, one or more preambles of the random access message of the random access procedure; and receiving, in the one or more uplink shared channel occasions in accordance with the time-domain mapping pattern, one or more uplink payload transmissions of the random access message of the random access procedure.
Aspect 15: The method of aspect 14, further comprising: receiving, in accordance with the time-domain mapping pattern, the one or more preambles in one or more consecutive random access occasions and the one or more uplink payload transmissions in one or more consecutive uplink shared channel occasions, where the one or more consecutive uplink shared channel occasions are subsequent to the one or more consecutive random access occasions.
Aspect 16: The method of any of aspects 14 through 15, further comprising: transmitting the control signaling indicating the time-domain mapping pattern, wherein the time-domain mapping pattern indicates that the one or more random access occasions and the one or more uplink shared channel occasions are interleaved in a time domain; and receiving the one or more preambles and the one or more uplink payload transmissions, wherein the one or more preambles and the one or more uplink payload transmissions are interleaved based at least in part on the time-domain mapping pattern.
Aspect 17: The method of any of aspects 14 through 16, wherein receiving the one or more preambles comprises: receiving, in accordance with the time-domain mapping pattern, the one or more preambles in one or more consecutive random access occasions that are TDMed within one or more random access slots.
Aspect 18: The method of any of aspects 14 through 17, wherein receiving the one or more uplink payload transmissions comprises: receiving, in accordance with the time-domain mapping pattern, the one or more uplink payload transmissions in one or more consecutive uplink shared channel occasions that are TDMed, wherein the one or more uplink payload transmissions are associated with a subset of the one or more preambles.
Aspect 19: The method of any of aspects 14 through 18, further comprising: receiving, in accordance with the time-domain mapping pattern, the one or more preambles in the one or more random access occasions and a first uplink payload transmission of the one or more uplink payload transmissions in a first uplink shared channel occasion of the one or more uplink shared channel occasions.
Aspect 20: The method of any of aspects 14 through 19, further comprising: receiving, in accordance with the time-domain mapping pattern, a first preamble of the one or more preambles in a first random access occasion of the one or more random access occasions and the one or more uplink payload transmissions in the one or more uplink shared channel occasions.
Aspect 21: The method of any of aspects 14 through 20, further comprising: transmitting the control signaling indicating the time-domain mapping pattern between the one or more random access occasions and the one or more uplink shared channel occasions, the time-domain mapping pattern based at least in part on a set of joint preamble and uplink payload transmission repetitions associated with one or more repetition levels, wherein the set of joint preamble and uplink payload transmission repetitions is TDMed, FDMed, or CDMed.
Aspect 22: The method of aspect 21, wherein, for the set of joint preamble and uplink payload transmission repetitions that is CDMed, a first joint payload and uplink payload transmission repetition is associated with one or more repetition levels.
Aspect 23: The method of any of aspects 14 through 22, further comprising: transmitting an RAR message in an RAR window, wherein a beginning of the RAR window is based at least in part on a last symbol of a last preamble of the one or more preambles or a last uplink payload transmission of the one or more uplink payload transmissions associated with a first repetition level.
Aspect 24: The method of any of aspects 14 through 23, further comprising: receiving a set of joint preamble and uplink payload transmission repetitions, wherein the set of joint preamble and uplink payload transmission repetitions is associated with one or more SSBs for a given repetition level.
Aspect 25: The method of aspect 24, wherein a quantity of SSBs associated with a highest identified RSRP is associated with a repetition level.
Aspect 26: An apparatus for wireless communication at a UE, comprising a processor; memory coupled with the processor; and instructions stored in the memory and executable by the processor to cause the apparatus to perform a method of any of aspects 1 through 13.
Aspect 27: An apparatus for wireless communication at a UE, comprising at least one means for performing a method of any of aspects 1 through 13.
Aspect 28: A non-transitory computer-readable medium storing code for wireless communication at a UE, the code comprising instructions executable by a processor to perform a method of any of aspects 1 through 13.
Aspect 29: An apparatus for wireless communication at a network entity, comprising a processor; memory coupled with the processor; and instructions stored in the memory and executable by the processor to cause the apparatus to perform a method of any of aspects 14 through 25.
Aspect 30: An apparatus for wireless communication at a network entity, comprising at least one means for performing a method of any of aspects 14 through 25.
Aspect 31: A non-transitory computer-readable medium storing code for wireless communication at a network entity, the code comprising instructions executable by a processor to perform a method of any of aspects 14 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a user equipment (UE), comprising:
receiving control signaling indicating a time-domain mapping pattern between one or more random access occasions and one or more uplink shared channel occasions for transmission of a random access message of a random access procedure;
transmitting, in the one or more random access occasions in accordance with the time-domain mapping pattern, one or more preambles of the random access message of the random access procedure; and
transmitting, in the one or more uplink shared channel occasions in accordance with the time-domain mapping pattern, one or more uplink payload transmissions of the random access message of the random access procedure.

2. The method of claim 1, further comprising:
transmitting, in accordance with the time-domain mapping pattern, the one or more preambles in one or more consecutive random access occasions and the one or more uplink payload transmissions in one or more consecutive uplink shared channel occasions, where the one or more consecutive uplink shared channel occasions are subsequent to the one or more consecutive random access occasions.

3. The method of claim 1, further comprising:
receiving the control signaling indicating the time-domain mapping pattern, wherein the time-domain mapping pattern indicates that the one or more random access occasions and the one or more uplink shared channel occasions are interleaved in a time domain; and
transmitting the one or more preambles and the one or more uplink payload transmissions, wherein the one or more preambles and the one or more uplink payload transmissions are interleaved based at least in part on the time-domain mapping pattern.

4. The method of claim 1, wherein transmitting the one or more preambles comprises:
transmitting, in accordance with the time-domain mapping pattern, the one or more preambles in one or more consecutive random access occasions that are time division multiplexed within one or more random access slots.

5. The method of claim 1, wherein transmitting the one or more uplink payload transmissions comprises:
transmitting, in accordance with the time-domain mapping pattern, the one or more uplink payload transmissions in one or more consecutive uplink shared channel occasions that are time division multiplexed, wherein the one or more uplink payload transmissions are associated with a subset of the one or more preambles.

6. The method of claim 1, further comprising:
transmitting, in accordance with the time-domain mapping pattern, the one or more preambles in the one or more random access occasions and a first uplink payload transmission of the one or more uplink payload transmissions in a first uplink shared channel occasion of the one or more uplink shared channel occasions.

7. The method of claim 1, further comprising:
transmitting, in accordance with the time-domain mapping pattern, a first preamble of the one or more preambles in a first random access occasion of the one or more random access occasions and the one or more uplink payload transmissions in the one or more uplink shared channel occasions.

8. The method of claim 1, further comprising:
receiving the control signaling indicating the time-domain mapping pattern between the one or more random access occasions and the one or more uplink shared channel occasions, the time-domain mapping pattern based at least in part on a set of joint preamble and uplink payload transmission repetitions associated with one or more repetition levels, wherein the set of joint preamble and uplink payload transmission repetitions is time division multiplexed, frequency division multiplexed, or code division multiplexed.

9. The method of claim 8, wherein, for the set of joint preamble and uplink payload transmission repetitions that is code division multiplexed, a first joint payload and uplink payload transmission repetition is associated with one or more repetition levels.

10. The method of claim 1, further comprising:
receiving a random access response message in a random access response window, wherein a beginning of the random access response window is based at least in part on a last symbol of a last preamble of the one or more preambles or a last uplink payload transmission of the one or more uplink payload transmissions associated with a first repetition level.

11. The method of claim 1, further comprising:
transmitting a set of joint preamble and uplink payload transmission repetitions, wherein the set of joint preamble and uplink payload transmission repetitions is associated with one or more synchronization signal blocks for a given repetition level.

12. The method of claim 11, further comprising:
selecting a first joint preamble and uplink payload transmission repetition of the set of joint preamble and uplink payload transmission repetitions based at least in part on a synchronization signal block associated with the first joint preamble and uplink payload transmission repetition corresponding to a highest identified reference signal received power.

13. The method of claim 11, wherein a quantity of synchronization signal blocks associated with a highest identified reference signal received power is associated with a repetition level.

14. A method for wireless communication at a network entity, comprising:
transmitting control signaling indicating a time-domain mapping pattern between one or more random access occasions and one or more uplink shared channel occasions for transmission of a random access message of a random access procedure;
receiving, in the one or more random access occasions in accordance with the time-domain mapping pattern, one or more preambles of the random access message of the random access procedure; and
receiving, in the one or more uplink shared channel occasions in accordance with the time-domain mapping pattern, one or more uplink payload transmissions of the random access message of the random access procedure.

15. The method of claim 14, further comprising:
receiving, in accordance with the time-domain mapping pattern, the one or more preambles in one or more consecutive random access occasions and the one or more uplink payload transmissions in one or more consecutive uplink shared channel occasions, where the one or more consecutive uplink shared channel occasions are subsequent to the one or more consecutive random access occasions.

16. The method of claim 14, further comprising:
transmitting the control signaling indicating the time-domain mapping pattern, wherein the time-domain mapping pattern indicates that the one or more random access occasions and the one or more uplink shared channel occasions are interleaved in a time domain; and
receiving the one or more preambles and the one or more uplink payload transmissions, wherein the one or more preambles and the one or more uplink payload transmissions are interleaved based at least in part on the time-domain mapping pattern.

17. The method of claim 14, wherein receiving the one or more preambles comprises:
receiving, in accordance with the time-domain mapping pattern, the one or more preambles in one or more consecutive random access occasions that are time division multiplexed within one or more random access slots.

18. The method of claim 14, wherein receiving the one or more uplink payload transmissions comprises:
receiving, in accordance with the time-domain mapping pattern, the one or more uplink payload transmissions in one or more consecutive uplink shared channel occasions that are time division multiplexed, wherein the one or more uplink payload transmissions are associated with a subset of the one or more preambles.

19. The method of claim 14, further comprising:
receiving, in accordance with the time-domain mapping pattern, the one or more preambles in the one or more random access occasions and a first uplink payload transmission of the one or more uplink payload transmissions in a first uplink shared channel occasion of the one or more uplink shared channel occasions.

20. The method of claim 14, further comprising:
receiving, in accordance with the time-domain mapping pattern, a first preamble of the one or more preambles in a first random access occasion of the one or more random access occasions and the one or more uplink payload transmissions in the one or more uplink shared channel occasions.

21-30. (canceled)
